(19) United States
(12) Patent Application Publication
(10) Pub. No.: US 2025/0210695 A1
(43) Pub. Date: Jun. 26, 2025

(54) ANODE-SOLID ELECTROLYTE SUB-ASSEMBLY FOR SOLID SECONDARY BATTERY, SOLID SECONDARY BATTERY INCLUDING THE SAME, AND METHOD OF MANUFACTURING THE SOLID SECONDARY BATTERY

(71) Applicants: Samsung Electronics Co., Ltd., Suwon-si (KR); UIF (University Industry Foundation), Yonsei University, Seoul (KR)

(72) Inventors: Kyounghwan Kim, Suwon-si (KR); Jonghyeok Park, Seoul (KR); Kwanghee Kim, Seoul (KR); Jaeho Shin, Suwon-si (KR); Yonggun Lee, Suwon-si (KR)

(21) Appl. No.: 18/979,878

(22) Filed: Dec. 13, 2024

(30) Foreign Application Priority Data
Dec. 21, 2023 (KR) 10-2023-0188828

(51) Int. Cl. H01M 10/0562; H01M 4/583; H01M 10/058; H01M 50/46

(52) U.S. Cl. CPC H01M 10/0562; H01M 4/583; H01M 10/058; H01M 50/46; H01M 2300/0068

(57) ABSTRACT

An anode-solid electrolyte sub-assembly for a solid secondary battery, and a method of manufacturing the same, wherein the anode-solid electrolyte sub-assembly includes an anode current collector, a mixed ionic-electronic conductor (MIEC) structure, the mixed ionic-electronic conductor structure between the anode current collector and a solid electrolyte. The mixed ionic-electronic conductor has a plurality of open portions that extend in a direction from the anode current collect towards the solid electrolyte and at least one end of an open portion of plurality of open portions is open. A plurality of lithiophilic metal material particles are disposed on the mixed ionic-electronic conductor structure, an interlayer is disposed between the mixed ionic-electronic conductor structure on which the lithiophilic metal material particles are disposed and the solid electrolyte. The interlayer includes an interlayer material comprising a carbon-containing anode compound; lithium; a mixture of a carbon-containing anode compound and at least one of a second metal or a metalloid; a composite of a carbon-containing anode compound and at least one of a second metal or a metalloid; or a combination thereof.

### CROSS-REFERENCES TO RELATED APPLICATION

This application is based on and claims priority to Korean Patent Application No. 10-2023-0188828, filed on Dec. 21, 2023, in the Korean Intellectual Property Office, and all the benefits accruing therefrom under 35 U.S.C. § 119, the content of which is herein incorporated by reference in its entirety.

### BACKGROUND

### 1. Field

The disclosure relates to an anode-solid electrolyte sub-assembly for a solid secondary battery, a solid secondary battery including the same, and a method of manufacturing the anode-solid electrolyte sub-assembly and the solid secondary battery.

### 2. Description of the Related Art

Since flammable organic solvents are generally not used in solid secondary batteries, the possibility of fires or explosions may be considerably reduced even when a short circuit occurs. Therefore, the safety of such solid secondary batteries may be considerably increased in comparison to lithium-ion batteries that use electrolytes.

In order to increase the energy density of such solid secondary batteries, lithium may be used as an anode active material. For example, the specific capacity (capacity per unit mass) of lithium metal is known to be about 10 times that of graphite which is commonly used as an anode active material. Therefore, by using lithium as an anode active material, solid secondary batteries may be thinner, with an increased capacity.

In order to increase the energy density of solid secondary batteries, a precipitation-type anode has been proposed in which a material that forms an alloy or compound with lithium is inserted between an anode and a solid electrolyte and used as a protective layer for lithium metal. However, there remains a need to develop an anode with improved properties.

### SUMMARY

An anode-solid electrolyte sub-assembly for a solid secondary battery is disclosed in which, after charging or discharging, a change in thickness of a battery is suppressed, and a change in internal stress is decreased.

An aspect provides a solid secondary battery including the anode-solid electrolyte sub-assembly with improved cell performance, and a method of manufacturing the same.

Additional aspects will be set forth in part in the description which follows and, in part, will be apparent from the description, or may be learned by practice of the presented embodiments of the disclosure.

An anode-solid electrolyte sub-assembly for a solid secondary battery, the anode-solid electrolyte sub-assembly including an anode current collector, a mixed ionic-electronic conductor (MIEC) structure disposed between the anode current collector and a solid electrolyte and having a plurality of open portions that extend in a direction from the anode current collector towards the solid electrolyte wherein at least one end of an open portion of the plurality of open portions is open, a plurality of lithiophilic metal material particles disposed on a surface of the MIEC structure, an interlayer between the MIEC structure on which the lithiophilic metal material particles are disposed and the solid electrolyte. The interlayer includes an interlayer material including a carbon-containing anode compound; lithium; a mixture of i) the carbon-based anode compound and ii) at least one of a second metal or a metalloid; a composite of i) the carbon-containing anode compound and ii) at least one of a second metal or a metalloid; or a combination thereof.

According to another aspect, a solid secondary battery that comprises a cathode and an anode-solid electrolyte sub-assembly disposed on the cathode, wherein a solid electrolyte of the anode-solid electrolyte sub-assembly is disposed between the cathode and an anode.

According to another aspect, a method of manufacturing a solid secondary battery, the method including preparing a MIEC structure, the MIEC structure having a plurality of open portions that extend in a direction and have a structure where at least one end of the open portion of the plurality of open portions is open, arranging lithiophilic metal material particles on the MIEC structure to prepare a MIEC structure on which the lithiophilic metal material particles are disposed, arranging an interlayer on the MIEC structure on which the lithiophilic metal material particles are disposed, to prepare the MIEC structure on which the interlayer is disposed, stacking the MIEC structure on which the interlayer is disposed on an anode current collector, to prepare a stack, wherein the MIEC structure is disposed between the interlayer and the anode current collector, arranging a solid electrolyte on the interlayer of the stack to form an anode-solid electrolyte sub-assembly, and arranging a cathode on another side of the solid electrolyte of the anode-solid electrolyte sub-assembly to manufacture the solid secondary battery.

According to another aspect, a method of manufacturing an anode-solid electrolyte sub-assembly, the method including preparing a MIEC structure, the MIEC structure having a plurality of open portions that extend in a direction and have a structure where at least one end of the open portion of the plurality of open portions is open, arranging lithiophilic metal material particles on the MIEC structure to prepare a MIEC structure on which the lithiophilic metal material particles are disposed, arranging an interlayer on the MIEC structure on which the lithiophilic metal material particles are disposed, to prepare the MIEC structure on which the interlayer is disposed, stacking the MIEC structure on which the interlayer is disposed on an anode current collector, to prepare a stack, wherein the MIEC structure is disposed between the interlayer and the anode current collector, arranging a solid electrolyte on the interlayer of the stack to form an anode-solid electrolyte sub-assembly.

### BRIEF DESCRIPTION OF THE DRAWINGS

The above and other aspects, features, and advantages of certain embodiments will be more apparent from the following description taken in conjunction with the accompanying drawings, in which:

FIGS. 1A to 1C are cross-sectional diagrams of a structure of an anode-solid electrolyte sub-assembly according to an embodiment;

FIG. 1D is a cross-sectional diagram of lithium precipitated in pores of a mixed ionic-electronic conductor (MIEC) structure after charging in the anode-solid electrolyte sub-assembly of FIG. 1B;

FIG. 1E is a cross-sectional diagram of a structure of a solid secondary battery including an anode-solid electrolyte sub-assembly according to an embodiment;

FIG. 2A is a graph illustrating voltage (volts, V) and pressure (megapascals, MPa) versus time (hours, h) for a charging and discharging process in the solid secondary battery of Example 1;

FIG. 2B is a graph illustrating voltage (volts, V) and pressure (megapascals, MPa) versus time (hours, h) for a charging and discharging process in the solid secondary battery of Comparative Example 1;

FIG. 2C is a graph illustrating voltage (volts, V) and pressure (megapascals, MPa) versus time (hours, h) for a charging and discharging process in the solid secondary battery of Comparative Example 2;

FIG. 3 is a graph illustrating voltage (volts, V) and pressure (megapascals, MPa) versus time (hours, h) for the solid secondary battery of Example 1 after five charge/discharge cycles;

FIG. 4A is a scanning electron micrograph energy dispersive X-ray analysis of a TiN nanotube prepared in Preparation Example 1;

FIG. 4B is a scanning electron micrograph energy dispersive X-ray analysis for silver nitrate (AgNO₃) of a TiN nanotube prepared in Preparation Example 1;

FIG. 4C is a scanning electron micrograph energy dispersive X-ray analysis for titanium (Ti) of a TiN nanotube prepared in Preparation Example 1;

FIG. 4D is a scanning electron micrograph energy dispersive X-ray analysis for nitrogen (N) of a TiN nanotube prepared in Preparation Example 1;

FIG. 4E is a scanning electron micrograph energy dispersive X-ray analysis for silver (Ag) of a TiN nanotube prepared in Preparation Example 1;

FIG. 4F is a scanning electron micrograph energy dispersive X-ray analysis of a TiN nanotube prepared in Preparation Example 1;

FIG. 5A is a scanning electron micrograph energy dispersive X-ray analysis of a TiN nanotube prepared in Preparation Example 4;

FIG. 5B is a scanning electron micrograph energy dispersive X-ray analysis of a TiN nanotube prepared in Preparation Example 4;

FIG. 5C is a scanning electron micrograph energy dispersive X-ray analysis for titanium (Ti) of a TiN nanotube prepared in Preparation Example 4;

FIG. 5D is a scanning electron micrograph energy dispersive X-ray analysis for nitrogen (N) of a TiN nanotube prepared in Preparation Example 4;

FIG. 5E is a scanning electron micrograph energy dispersive X-ray analysis of for gold (Au) of a TiN nanotube prepared in Preparation Example 4;

FIG. 6A is a scanning electron micrograph energy dispersive X-ray analysis of a TiN nanotube prepared in Comparative Preparation Example 1;

FIG. 6B is a scanning electron micrograph energy dispersive X-ray analysis of a TiN nanotube prepared in Comparative Preparation Example 1;

FIG. 6C is a scanning electron micrograph energy dispersive X-ray analysis for titanium (Ti) of a TiN nanotube prepared in Comparative Preparation Example 1;

FIG. 6D is a scanning electron micrograph energy dispersive X-ray analysis for nitrogen (N) of a TiN nanotube prepared in Comparative Preparation Example 1;

FIG. 6E is a scanning electron micrograph energy dispersive X-ray analysis for zinc (Zn) of a TiN nanotube prepared in Comparative Preparation Example 1;

FIG. 6F is a scanning electron micrograph energy dispersive X-ray analysis for oxygen (O) of a TiN nanotube prepared in Comparative Preparation Example 1;

FIGS. 7A to 7D is a graph illustrating voltage (volts, V) versus; specific capacity (milliampere-hours per gram, mAhg-1) of a charging and discharging process of the solid secondary batteries of Example 1, Comparative Example 1, Comparative Example 3, and Comparative Example 4, respectively; and

FIG. 8 is a graph illustrating lithium nucleation overpotential (un in volts, V) versus current density (milliamperes per square centimeter, mA/cm²) for the solid secondary batteries of Example 1 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used in the disclosure have the same meaning as commonly understood by one of ordinary skill in the art to which the disclosure belongs. In addition, it will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Embodiments are described in the disclosure with reference to cross-sectional views which are schematic diagrams of idealized embodiments. As such, variations from the shapes of the illustrations as a result, for example, of manufacturing techniques and/or tolerances, are to be expected. Thus, the embodiments described in the disclosure should not be construed as limited to the particular shapes regions of illustrated in the disclosure but may include deviations in shapes that result, for example, from manufacturing. For example, regions illustrated or described as being flat may be typically rough and/or have nonlinear features. Moreover, sharp-drawn angles may be round. Thus, regions illustrated in the drawings are schematic in nature and their shapes are not intended to illustrate the actual shape of a region and are not intended to limit the scope of the claims.

The present inventive concept may, however, be embodied in different forms and should not be construed as limited to the embodiments described in the disclosure. These embodiments are provided so that the disclosure will be thorough and complete, and will fully convey the scope of the present inventive concept to those skilled in the art. Like reference numerals designate like elements.

When it is described that an element is “on” another element, it will be understood that the element may be disposed directly on another element or still another element may be interposed therebetween. On the other hand, when it is described that an element is “directly on” another element, still another element is not interposed therebetween.

Terms such as “first,” “second,” “third,” and the like may be used in this disclosure to describe various components, components, regions, layers, and/or sections; Layers and/or zones should not be limited by these terms. These terms are only used to distinguish one element, component, region, layer, or section from another region, layer, or section. Thus, a first element, component, region, layer, or section described below may be termed a second element, component, region, layer, or section without departing from the teachings of the disclosure.

The term used in the disclosure is intended to describe only a specific embodiment and is not intended to limit the present inventive concept. As used herein, the singular forms “a,” “an,” and “the” are intended to include the plural forms, including “at least one,” unless the content clearly indicates otherwise. “At least one” should not be construed as being limited to the singular. As used in the disclosure, the term “and/or” includes any and all combinations of one or more of the associated listed items. The terms “includes,” “including,” “comprises,” and/or “comprising,” when used in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be used herein to easily describe one element or feature's relationship to another element or feature. It will be understood that the spatially relative terms are intended to encompass different orientations of a device in use or operation in addition to the orientation illustrated in the drawings. For example, when a device in the drawings is turned over, elements described as “below” or “beneath” other elements or features would then be “above” or “over” the other elements or features. Thus, the example term “below” may encompass both orientations of above and below. The device may be otherwise oriented (rotated 90 degrees or at other orientations), and the spatially relative terms used in the disclosure may be interpreted accordingly.

“Group” refers to a group of the periodic table of the elements according to the International Union of Pure and Applied Chemistry (“IUPAC”) Groups 1-18 group classification system.

In the disclosure, the term “particle diameter” refers to an average diameter when particles are spherical and refers to an average major axis length when particles are non-spherical. A particle diameter may be measured using a particle size analyzer (PSA). A “particle diameter” is, for example, an average particle diameter. An “average particle diameter” refers to, for example, a median particle diameter (D50).

D50 refers to a particle size corresponding to a 50% cumulative volume when a particle size distribution measured through a laser diffraction method is calculated from particles having a smaller particle size.

D90 refers to a particle size corresponding to a 90% cumulative volume when a particle size distribution measured through a laser diffraction method is calculated from particles having a smaller particle size.

D10 refers to a particle size corresponding to a 10% cumulative volume when a particle size distribution measured through a laser diffraction method is calculated from particles having a smaller particle size.

The term “metal” as used herein includes all of metals and metalloids such as silicon and germanium in an elemental or ionic state. The term “metal” is defined to include a metal, a metalloid, or a combination thereof.

The term “electrode active material” as used herein refers to an electrode material that may undergo lithiation and delithiation.

As used herein, the terms “charge” and “charging” refer to a process of providing electrochemical energy to a battery, and as used herein, the terms “discharge” and “discharging” refer to a process of removing electrochemical energy from a battery.

As used herein, the terms “positive electrode” and “cathode” refer to an electrode at which electrochemical reduction and lithiation occur during a discharging process, and as used herein, the terms “negative electrode” and “anode” as used herein refer to an electrode at which electrochemical oxidation and delithiation occur during a discharging process.

In the present disclosure, the aspect ratio represents the ratio (L1/L2) of the major axis length L1 (eg, length) and the minor axis length L2 (eg, diameter). Here, the aspect ratio, major axis length, minor axis length, length, and diameter represent the average aspect ratio, average major axis length, average minor axis length, average length, and average diameter. The aspect ratio may be evaluated using a scanning electron microscope.

While specific embodiments have been described, alternatives, modifications, variations, improvements, and substantial equivalents that are or may be presently unforeseen may arise to applicants or others skilled in the art. In some embodiments, the appended claims as filed and as they may be amended are intended to embrace all such alternatives, modifications, variations, improvements, and substantial equivalents.

Hereinafter, an anode-solid electrolyte sub-assembly for a solid secondary battery, a solid secondary battery including the same, and a method of manufacturing the solid secondary battery according to an embodiment will be described in more detail with reference to the accompanying drawings. In the drawings, like reference numerals refer to like elements throughout, and the size, the thickness, or the like of each component in the drawings may be exaggerated for clarity and convenience of description. Meanwhile, embodiments set forth herein are merely examples and various changes may be made therein.

In the present specification, a “composite” of a carbon-containing anode active material and a second metal refers to a material that is a composite material of a carbon-containing anode active material and a second metal. Conceptually, the “composite” of the carbon-containing anode active material and the second metal refers to a material which, after two or more types of materials are formed into a composite, is formed to have better performance than the original materials while each material maintains its original phase physically and chemically. The “composite” of the carbon-containing anode active material and the second metal is different from a mixture of a carbon-containing anode active material and a second metal.

Hereinafter, an anode-solid electrolyte sub-assembly for a solid secondary battery, a solid secondary battery including the same, and a method of manufacturing the solid secondary battery according to an embodiment will be described in detail.

A precipitation-type anode has been proposed in which a material that forms an alloy or compound with lithium is inserted between an anode and a solid electrolyte of a solid secondary battery and used as a protective layer for a lithium metal layer. As lithium moves between an anode current collector and a protective layer during charging of such a solid secondary battery, a cell thickness may be changed to generate strain and internal stress inside a battery, which may adversely affect the driving characteristics of the battery. Therefore, in such a solid secondary battery, a thickness of an anode may be changed due to lithium precipitation to generate stress and strain inside a battery, which may deteriorate the driving characteristics of the battery. Therefore, there is a need for a strain-free anode structure which, even when lithium accumulates during charging, prevents a change in thickness or pressure of a battery and of which internal stress is not generated. An anode using a vertical tubular mixed ionic-electronic conductor (MIEC) support as a lithium support has been proposed.

When an anode using a vertical tubular MIEC support as a lithium support is used, a current may be concentrated on protrusions of the vertical tubular MIEC support, which forms an interface with a solid electrolyte, and thus lithium dendrites may be formed on the protrusions, which may reduce battery capacity or may cause a short circuit. In order to solve such a problem, a method of forming an electronic and Li-ion insulator (ELI) layer on an MIEC support has been proposed. When such an ELI layer is used, a process time and cost may increase due to the application of a vacuum deposition process, an interfacial insulating layer may also be added, and the interfacial insulating layer may serve as a resistance film, which may also deteriorate the high-rate characteristics of a battery.

Herein an anode-solid electrolyte sub-assembly for a solid secondary battery is disclosed in which, a MIEC structure including a plurality of open portions, which extend in a direction and have a structure of which at least one end of an open portion of the plurality of open portion is open, may be used as a lithium support. A lithiophilic coating layer may be disposed on the MIEC structure and an interlayer capable of inducing smooth ion and current dispersion may be disposed on the MIEC structure on which the lithiophilic coating layer is disposed so that there is almost no change in internal stress even during repeated charging or discharging.

An anode-solid electrolyte sub-assembly according to an embodiment may include an anode current collector, a MIEC structure, the MIEC structure disposed between the anode current collector and a solid electrolyte. The MIEC structure may have a plurality of open portions that extend in a direction from the anode current collector towards the solid electrolyte where at least one end of an open portion of the plurality of open portions is open. A plurality of lithiophilic metal material particles may bedisposed on a surface of the MIEC structure, an interlayer may be disposed between the MIEC structure on which the plurality of lithiophilic metal material particles are disposed and the solid electrolyte. The interlayer may include an interlayer material including: a carbon-containing anode compound; lithium; a mixture of i) a carbon-containing anode compound, and ii) at least one of a second metal or a metalloid; a composite of i) a carbon-containing anode compound, and ii) at least one of a second metal or a metalloid; or a combination thereof.

In the disclosure, “lithiophilic metal material particles disposed on a surface of the MIEC structure” means that the lithiophilic metal material particles are disposed on the open portion, on an inside (wall), or on a surface of the MIEC structure.

The solid electrolyte may be positioned on the interlayer and may be disposed opposite to the MIEC structure.

The plurality of lithiophilic metal material particles may be discontinuously disposed on the MIEC structure, for example, applied in an island (e.g., agglomerate) form. In this way, when the lithiophilic metal material particles are discontinuously applied onto the MIEC structure, lithium may pass through the interlayer and may smoothly move into the opening of the MIEC structure to be appropriately precipitated, and a space between the discontinuous lithiophilic metal material particles may offset an increase in volume of an alloy phase. In addition, lithium dendrites may be suppressed through current dispersion in protrusions of the MIEC structure, a change in internal stress may be reduced even during repeated charging or discharging, and a reduced state may be easily maintained. When the lithiophilic metal material particles are disposed in the form of a continuous film on the MIEC, lithium may be precipitated at a portion other than the open portion of the MIEC structure, which may increase the internal pressure of a battery and may reduce the initial efficiency of the battery.

The plurality of lithiophilic metal material particles may include, for example, Au, Ag, Zn, Mg, Al, Zn, LiF, or a combination thereof.

The plurality of lithiophilic metal material particles may have an average particle size that is less than or equal to an average diameter of the open portion of the MIEC structure. When the lithiophilic metal material particles have such a size range, lithium may smoothly move into the MIEC structure to be precipitated, thereby effectively preventing an increase in internal pressure of a cell.

The average particle size of the lithiophilic metal material particles may be, for example, about 10 nanometers (nm) to about 60 nm, about 15 nm to about 55 nm, about 20 nm to about 53 nm, about 20 nm to about 50 nm, or about 20 nm to about 35 nm. When the average particle size of the lithiophilic metal material particles is in such a range, even during repeated charging or discharging, lithium may smoothly move into the MIEC structure to be precipitated, thereby preventing an increase in internal pressure of a cell.

The lithium nucleation overpotential of the MIEC structure coated with the lithiophilic metal material particles may be adjusted to be less than the lithium nucleation overpotential of the interlayer. In this case, lithium generated in a cathode during charging may pass through the interlayer to be precipitated inside the MIEC structure, thereby manufacturing a solid secondary battery capable of performing strain-free driving almost without generating internal stress.

According to an embodiment, the lithium nucleation overpotential of the MIEC structure on which the lithiophilic metal material particles are disposed may be less than the lithium nucleation overpotential of the MIEC structure on which the lithiophilic metal material particles are not disposed.

According to an embodiment, the lithium nucleation overpotential of the MIEC structure may be less than or equal to the lithium nucleation overpotential of the interlayer. The lithium nucleation overpotential of the MIEC structure on which the lithiophilic metal material particles are disposed may be about 5 millivolts (mV) to about 15 mV or about 5.5 mV to about 10 mV when a current density is about 0.1 milliamperes per square centimeter (mA/cm²) to about 0.5 mA/cm². In this way, when the lithium nucleation overpotential of the MIEC structure on which the lithiophilic metal material particles are disposed is reduced, a solid secondary battery with improved output characteristics may be manufactured. Here, nucleation overpotential may be measured at a current density of about 0.05 mA/cm² to about 0.5 mA/cm² and will be evaluated in Evaluation Example 4 to be described below.

A content of the lithiophilic metal material particles may be about 0.01 parts by weight to about 5 parts by weight, about 0.05 parts by weight to about 3 parts by weight, or about 0.1 parts by weight to about 3 parts by weight with respect to 100 parts by weight of the MIEC structure. When the content of the lithiophilic metal material particles is in such a range, lithium may be precipitated inside the MIEC structure, thereby manufacturing a solid secondary battery capable of performing strain-free driving almost without generating internal stress.

A coverage ratio of an area occupied by the lithiophilic metal material particles to an area of the MIEC structure may be at least 0.30 or greater or about 0.30 to about 0.80. In the disclosure, the coverage ratio is defined as a ratio of an area occupied by the lithiophilic metal material particles to an area of the MIEC. When the coverage ratio is in such a range, lithium may be precipitated inside the MIEC structure, thereby manufacturing a solid secondary battery capable of performing strain-free driving almost without generating internal stress.

The plurality of open portions, for example, open regions, may have a structure of which one end portion or two end portions are open. A shape of the open portion may be a vertical tube shape, a straight line shape, a cross shape, a circular shape, an oval shape, a triangular shape, a quadrangular shape, a pentagonal shape, a hexagonal shape, a stripe shape, a net shape, a honeycomb shape, or a combination thereof.

The plurality of open portions having a structure of which at least one end is open may have a vertical tube shape extending in a direction from an anode current collect towards a solid electrolyte. A space in which lithium may be stored may be present inside the open portion, for example, inside a tube, and the space may include a plurality of open pores. As used herein, the term “open pore” may refer to a pore in which the inside of a tube is exposed, for example, connected to the outside. Here, the open pore may refer to a space in a tube. A shape of a horizontal cross-section of the open pore is not limited and may be, for example, a circular shape, an oval shape, a triangular shape, a square shape, a rectangular shape, or a hexagonal shape.

The plurality of open portions, for example the plurality of open pores, may include a plurality of tubules, and each of the tubules may have a cross-sectional width of less than 300 nm. The tubules may have, for example, a honeycomb structure.

At least a portion of the open portion, for example, at least a portion of the vertical tube, may contain an interlayer material.

The MIEC structure may have, for example, a vertical nanotube shape.

In the anode-solid electrolyte sub-assembly according to an embodiment, a phenomenon in which a current is concentrated on vertical nanotube structure protrusions (tube tips) may be prevented, and a current may be uniformly distributed to prevent the formation of lithium dendrites on the protrusions, thereby enabling normal driving of a cell.

The MIEC structure may not store or release lithium metal or may not react with lithium. In the MIEC structure, lithium metal may be stored in the plurality of open portions, for example, the plurality of open pores, and the lithium metal may be released from the plurality of open pores to facilitate the movement of the lithium metal.

The MIEC structure may form a conductive path defined by at least portions of the pores, and an average pore diameter of the pores may be about 5 nm to about 200 nm, about 50 nm to about 150 nm, or about 60 nm to about 120 nm. A thickness of the MIEC structure may be about 1 micrometer (μm) to about 100 μm, about 3 μm to about 80 μm, about 5 μm to about 60 μm, or about 15 μm to about 40 μm.

As used herein, the term “average pore diameter” may refer to an average diameter when pores are spherical and may refer to an average major axis length when pores are non-spherical. The average particle diameter and average major axis length may represent average values of measured particle diameters and measured major axis lengths, respectively. An average particle diameter and an average major axis length may be evaluated through image analysis using a scanning electron microscope (SEM) or transmission electron microscope. The average particle diameter may be, for example, an average particle diameter observed by using a SEM and may be calculated as an average value of particle diameters of about 10 to 30 particles by using a SEM image.

When the MIEC structure has a vertical tube shape, an average pore size may represent an average inner diameter of a tube.

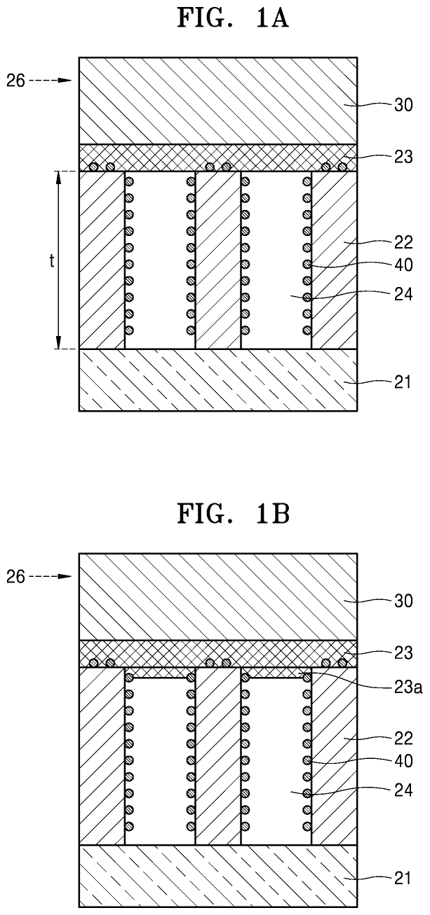

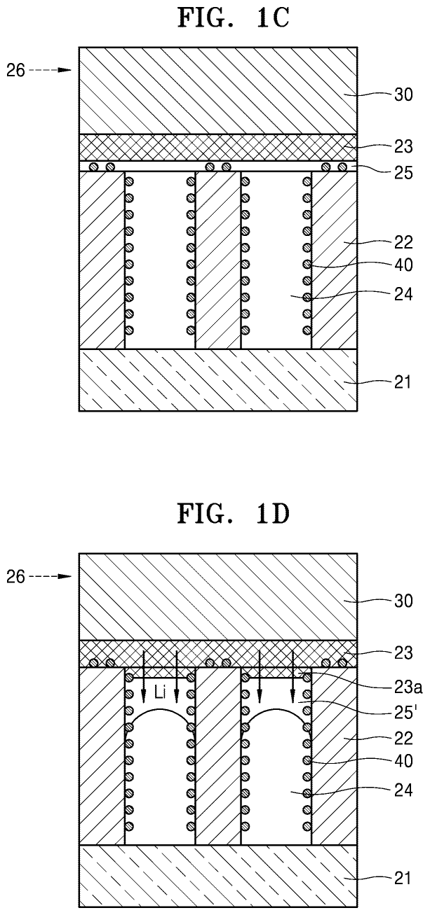

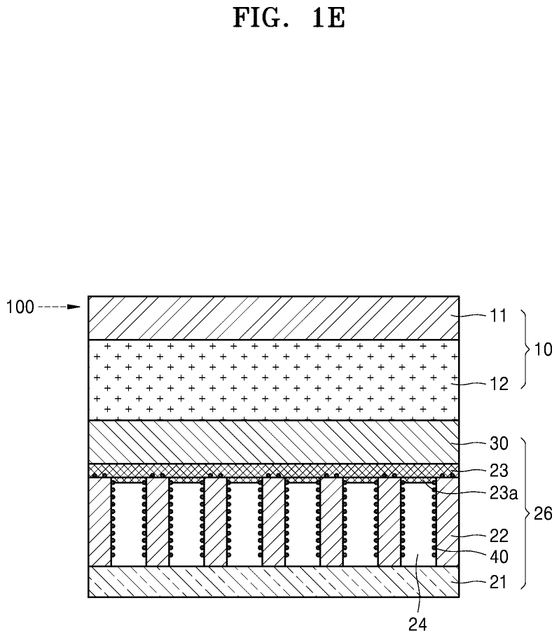

FIGS. 1A to 1D are views for describing a structure of an anode-solid electrolyte sub-assembly according to an embodiment.

According to an embodiment, as shown in FIG. 1A, the anode-solid electrolyte sub-assembly 26 may include a MIEC structure 22, which contains a MIEC having a plurality of open pores 24 vertically extending in a direction t from an anode current collector 21 towards a solid electrolyte 30. During charging and/or discharging of a battery, lithium may be moved into and/or precipitated in the open pores 24. An anode may include the anode current collector 21.

An interlayer 23 may be stacked on the MIEC structure 22, and a solid electrolyte 30 may be disposed on the interlayer 23. Lithiophilic metal material particles 40 may be disposed on the MIEC structure 22. The lithiophilic metal material particles 40 may be applied in an island (e.g., agglomerate) form. When the lithiophilic metal material particles 40 are applied, lithium passing through the interlayer 23 may smoothly move into the MIEC structure 22. The interlayer 23 may be formed between the MIEC and the solid electrolyte 30 to prevent a current from being concentrated on protrusions of the MIEC structure 22, thereby suppressing a short circuit.

In FIG. 1A, the lithiophilic metal material particles 40 may be regularly disposed at certain intervals, but may also be irregularly disposed. A thickness of a coating film containing the lithiophilic metal material particles 40 may be, for example, about 10 nm to about 60 nm.

The MIEC structure 22 may include a material having physical properties capable of withstanding mechanical stress generated by lithium metal without storing and/or releasing the lithium metal. The MIEC structure 22 may be formed of any material as long as the material may form vertical open pores.

The MIEC may include a material that has electrical conductivity and ionic conductivity to lithium which is used as an alkali metal. The MIEC structure 22 may include, for example, at least one of a carbon-containing material, silicon (Si), aluminum (Al), titanium nitride (TiN), titanium carbide (TIC), tantalum nitride, tungsten nitride, iron nitride, nickel (Ni), or niobium oxynitride; a lithiated compound of at least one of a carbon-containing material, silicon (Si), aluminum (Al), titanium nitride (TiN), titanium carbide (TiC), tantalum nitride, tungsten nitride, iron nitride, nickel (Ni), or niobium oxynitride; or a combination thereof.

The MIEC may include a material including titanium nitride (TiN), titanium carbide (TiC), Ta₃N₅, FeₓN, wherein 2≤x≤4, W₂N, NbₐOₓN_{y}, wherein 0≤a≤2, 0≤x≤2, and 0≤y≤2, or a combination thereof; a lithiated compound of the material; a mixture of the material and a carbon-containing material; a composite of the material and a carbon-containing material; or a combination thereof.

FeₓN, wherein 2≤x≤4, may be, for example Fe₂N or Fe₃N. NbₐOₓN_{y}, wherein 0≤a≤2, 0≤x≤2, and 0≤y≤2, may be, for example, Nb₂N_{0.88}O_{0.12}.

Among MIEC structure materials, titanium nitride (TiN) may be a material that is thermodynamically and electrochemically stable to lithium, does not react with lithium, and does not generate a solid electrolyte interphase (SEI) when coming into contact with lithium. Titanium nitride may have excellent mechanical properties.

According to another embodiment, the MIEC structure 22 may be formed of a carbon-containing material, and the MIEC formed of a carbon-containing material may include a mixture of graphite and amorphous carbon. As a result, a phase boundary between lithium metal and lithiated carbon may have a spatially varying free volume between amorphous carbon clusters, which may also increase a diffusion rate.

According to another embodiment, the MIEC structure 22 may contain a mixture of TiN, graphite, and amorphous carbon.

The MIEC according to another embodiment may be formed from lithiated carbon and a lithium-friendly (for example, lithiophilic) coating film (e.g., Li₂O).

A porosity of the MIEC structure 22 may be selected within a range that maintains a framework of the MIEC structure 22 and may be 60% or greater, about 60% to about 90%, about 65% to about 85%, or about 70% to about 80%. Here, % may refer to volume percent (vol %). Porosity may be evaluated through image analysis using SEM analysis. When the porosity is in such a range, lithium may be stored in the open pores during charging.

In a MIEC structure having a plurality of pores, for example, a plurality of open pores, an interval between the plurality of pores, for example, an interval between the plurality of open pores, may refer to a separation distance between centers of two adjacent pores. Specifically, in the present specification, in a MIEC structure which contains a plurality of pores including a first pore and a second pore disposed adjacent to the first pore, an interval between the pores may refer to a distance from a center of the first pore to a center of the second pore.

The interval between the pores may be measured by using a method of evaluating a pore size, for example, using a SEM. The interval between the pores may be equal to a width (separation distance) between adjacent tubes in a vertical tube and may be less than, for example, about 300 nm. When the interval between the open pores is excessively wide, it may be difficult to provide an effective conduction path.

In an embodiment, a thickness of a wall of a tube may be about 1 nm to about 30 nm, and a height of the tube may be at least 1 μm to about 20 μm, for example, about 10 μm.

The MIEC structure 22 may be, for example, a TiN vertical tube (hereinafter referred to as a vertical nanotube) having a vertical open pore. The vertical nanotube may have a three-dimensional structure and may be surface-treated. A lithiophilic coating film may be formed through surface treatment, which may increase electrical conductance and ionic conductance between the MIECs. As the lithiophilic coating film for example, a ZnOₓ- or Al₂O₃-containing coating film may be deposited on a surface of the open pores. A thickness of the coating film may be, for example, about 0.5 nm to about 5 nm, about 1 nm to 3 about nm, or about 1 nm. When such a coating film is formed, the wettability of Li metal toward the MIEC may be increased. The ZnOₓ-coating film or Al₂O₃-coating film may be formed by using, for example, atomic layer deposition (ALD).

The vertical nanotube, for example, the TiN vertical nanotube, may be prepared by using various methods such as anodizing methods and growth processes.

An aspect ratio of the vertical nanotube may be 10 or greater or 20 or greater. The aspect ratio of the vertical nanotube may be, for example, about 10 to about 100,000, about 10 to about 80,000, about 10 to about 50,000, about 10 to about 10,000, about 10 to about 5,000, about 100 to about 1,000, about 200 to about 800, or about 300 to about 700. The aspect ratio of the vertical nanotube may be, for example, a ratio of a length of a major axis passing through a center of the vertical nanotube to a length of a minor axis passing through the center of the vertical nanotube and perpendicular to the major axis, that is, a diameter of the vertical nanotube.

An average diameter of the vertical nanotubes may be, for example, about 60 nm to about 120 nm or about 90 nm to about 110 nm.

An average length of the vertical nanotubes may be, for example, about 1 μm to about 100 μm, about 3 μm to about 80 μm, about 5 μm to about 60 μm, or about 15 μm to about 40 μm. As the average length of the vertical nanotubes increases, the internal resistance of an anode may decrease. When the average length of the vertical nanotubes is excessively short, the capacity of a battery may be reduced.

The average diameter and average length of the vertical tubes may be evaluated through SEM analysis or laser diffraction analysis.

The vertical nanotube may include, for example, a nanotube primary structure, a nanotube secondary structure formed by aggregation of a plurality of nanotube primary particles, or a combination thereof.

The nanotube primary structure may be one nanotube unit. The nanotube secondary structure may be a structure formed by the nanotube primary structures being entirely or partially gathered to form a bundle-type nanotube or a rope-type nanotube. The nanotube secondary structure may include, for example, a bundle-type nanotube, a rope-type nanotube, or a combination thereof. An average diameter and/or average length of the nanotube secondary structure may be measured by using laser diffraction or a SEM.

The anode-solid electrolyte sub-assembly of FIG. 1B may be the same as the anode-solid electrolyte sub-assembly of FIG. 1A, except that an interlayer material is introduced into at least portions of a plurality of vertical open pores 24 so that a first interlayer 23a is disposed in the plurality of vertical open pores 24.

As shown in FIG. 1B, the first interlayer 23a may be formed by providing the interlayer material on an upper end of the plurality of vertical open pores 24 provided in a MIEC structure 22 during a process of stacking an interlayer 23 on the MIEC structure 22.

The first interlayer 23a may have a composition that is the same as or different from a composition of the interlayer 23. When the interlayer 23 and the first interlayer 23a have the same composition, a separate layer may not be provided, but in FIG. 1B, for convenience, the interlayer 23 and the first interlayer 23a are shown as being distinguished from each other.

The first interlayer 23a fills pores down to a depth of about 0.1 μm to about 2 μm on the MIEC structure 22 and thus may have some structures that intersect each other at an interface between the MIEC structure 22 and the interlayer 23 in a cross section. Here, the depth may refer to a depth by which the interlayer material penetrates into a tube which is the MIEC structure 22.

A thickness ratio of the interlayer 23 formed on the MIEC structure 22 to the first interlayer 23a is not particularly limited, but may be, for example, about 3:1 to about 20:1, about 4:1 to about 15:1, or about 5:1 to about 8:1. When such a thickness ratio is used, a solid secondary battery, in which the binding force between a MIEC structure and an interlayer and the charging or discharging characteristics may be improved, may be manufactured. In the disclosure, a solid secondary battery may include, for example, an all-solid secondary battery.

As shown in FIG. 1C, the anode-solid electrolyte sub-assembly according to another embodiment may have a structure in which a first metal thin film 25 is further disposed between a MIEC structure 22 and an interlayer 23. A second metal thin film (not shown) may be further disposed between the interlayer 23 and a solid electrolyte 30. A thickness of the metal thin film may be, for example, about 0.1 nm to about 100 nm. When a metal thin film having such a thickness is formed, the charging or discharging characteristics of a solid secondary battery may be further improved.

The metal thin film may be further formed as a precipitated layer in an operation of charging a solid secondary battery, an operation of arranging an anode current collector on an interlayer (for example, a contacting or bonding operation), or both the operations.

FIG. 1D illustrates that, during charging in the anode-solid electrolyte sub-assembly of FIG. 1B, lithium ions, which move from a cathode and pass through the interlayer 23 to be precipitated, to fill a portion of the open pore 24. As shown in the drawing, for example, lithium may be stored by being precipitated in a larger amount on a wall of the vertical tube in comparison to a center of the vertical tube., During charging, lithium may be precipitated by lithium ions moving from a cathode and passing through a first anode active material layer.

FIG. 1E is a view for describing a structure of a solid secondary battery including an anode-solid electrolyte sub-assembly according to an embodiment. The solid secondary battery may include, for example, an all-solid secondary battery.

On a MIEC structure, lithiophilic metal material particles 40 may be disposed in an agglomerate form. When such a structure is formed, lithium may pass through an interlayer to be smoothly precipitated in an opening of the MIEC structure which has a higher affinity for lithium than the interlayer. When the interlayer has a higher affinity for lithium than the MIEC structure, some lithium may remain in the interlayer to be precipitated inside the interlayer or at an interface between the interlayer and the MIEC structure, which may increase the internal pressure of a battery.

The interlayer may include an interlayer material having an ionic conductivity of 10⁻⁸ siemens per centimeter (S/cm) or greater and an electronic conductivity of 4.0×10⁻⁹ S/cm or greater. The interlayer material may have mechanical properties that provide both ionic conductivity and electronic conductivity and control stress generated due to lithium precipitation.

The electronic conductivity of the interlayer material may be, for example, 4.0×10⁻⁹ S/cm or greater, 1.0×10⁻⁸ S/cm or greater, 4.0×10⁻⁸ S/cm or greater, 1.0×10⁻⁷ S/cm or greater, 4.0×10⁻⁷ S/cm or greater, 1.0×10⁻⁶ S/cm or greater, or 1.0×10⁻⁵ S/cm or greater at a temperature of 25° C. Since the interlayer material has such high electronic conductivity, the internal resistance of a solid secondary battery including the interlayer material may be reduced. The interlayer may be present between the MIEC structure and a solid electrolyte to prevent a current from being concentrated on protrusions of a MIEC, thereby suppressing a short circuit.

The ionic conductivity of the interlayer material may be, for example, 1.0×10⁻⁸ S/cm or greater, 1.0×10⁻⁶ S/cm or greater, 5.0×10⁻⁶ S/cm or greater, 1.0×10⁻⁵ S/cm or greater, or 5.0×10.5 S/cm or greater. Since the interlayer material has such ionic conductivity, the internal resistance of a solid secondary battery including the interlayer material may be reduced.

In addition, the interlayer may contain lithium or a material that alloys with lithium or forms a compound with lithium.

According to an embodiment, the interlayer may contain an interlayer material that contains lithium; a carbon-containing anode compound; a mixture of i) a carbon-containing anode compound and ii) at least one selected from a second metal and a metalloid; a composite of i) a carbon-containing anode compound and ii) at least one selected from a second metal and a metalloid; or a combination thereof. The interlayer may include, for example, a carbon-containing anode active material, a second metal, a metalloid, or a combination thereof.

At least one of the second metal or the metalloid may include at least one of tin (Sn), indium (In), silicon (Si), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), molybdenum (Mo), silver (Ag), sodium (Na), potassium (K), calcium (Ca), yttrium (Y), bismuth (Bi), tantalum (Ta), hafnium (Hf), gold (Au), barium (Ba), vanadium (V), strontium (Sr), tellurium (Te), or lanthanum (La).

A binder may be added to the interlayer.

A thickness of the interlayer may be, for example, about 1 μm to about 20 μm, about 3 μm to about 15 μm, or about 5 μm to about 12 μm. As used herein, the term “thickness” may refer to an average thickness. The average thickness may be measured by using a SEM. When the thickness of the interlayer is in such a range, the interlayer may have an excellent effect of suppressing lithium dendrites and may not serve as a resistance film, thereby manufacturing a solid secondary battery having excellent high-rate characteristics.

At least a portion of a vertical open pore may contain the interlayer material. When the interlayer material is contained in at least portions of pores to form a first interlayer, a thickness ratio of the interlayer formed on the MIEC structure to the first interlayer may be, for example, about 3:1 to about 20:1, about 4:1 to about 15:1, or about 5:1 to about 8:1.

An average diameter of the pores in the MIEC structure may be about 5 nm to about 200 nm, and an average diameter of the pores in the interlayer may be about 0.1 nm to about 100 nm, about 1 nm to about 90 nm, about 5 nm to about 80 nm, about 10 nm to about 70 nm, about 30 nm to about 60 nm, or about 35 nm to about 55 nm.

The MIEC structure may have a larger average pore diameter than an average pore diameter of the interlayer. When the MIEC structure and the interlayer have such a pore diameter gradient, Li may move to the MIEC structure without Li being precipitated in the interlayer, and the interlayer may uniformly provide a Li seed. In the MIEC structure having a large pore diameter, Li that uniformly descends from the interlayer may be precipitated and stored in the MIEC structure, and stress may not be generated, which may reduce a change in internal stress.

As shown in FIG. 1E, the solid secondary battery according to an embodiment may have a structure in which a cathode 10 including a cathode active material layer 12 and a cathode current collector 11 is stacked on a solid electrolyte 30 of an anode-solid electrolyte sub-assembly 26 of FIG. 1B. As shown in FIG. 1E, the anode-solid electrolyte sub-assembly having the structure of FIG. 1B is illustrated, and the solid secondary battery may include an anode-solid electrolyte sub-assembly having the stacked structure of FIG. 1A or 1C.

In FIG. 1A or 1C, the MIEC structure is shown as having empty pores, but as shown in FIG. 1D, the MIEC structure may include lithium 25′ precipitated in open pores 24 after charging.

A charging process of a solid secondary battery according to an embodiment will be described as follows.

The solid secondary battery may be charged, lithium metal ions (Lit) may be transported from a cathode to an anode through the entirety of a solid electrolyte, lithium may be transported from the solid electrolyte to an interlayer, and the interlayer may assist in lithium precipitation. As a result, precipitated lithium may be moved and stored in at least a portion of an open pore of a MIEC structure which has electrical conductivity and ionic conductivity properties with respect to lithium ions. Electrons may be supplied into the anode and may be moved toward the cathode. Lithium may be precipitated in a larger amount in an edge region of the pore of the MIEC structure as compared with a central area thereof.

After charging, the open pore of the MIEC structure may contain a first metal material, and the first metal material may be lithium, a lithium-first metal (M1) alloy, or a combination thereof. Here, an average particle size of the first metal material may be about 0.1 nm to about 200 nm.

The first metal (M1) material may be, for example, the first metal (M1), the lithium-first metal (M1) alloy, or a combination thereof, and the first metal (M1) may be a metal. The metal may include, for example, tin (Sn), indium (In), silicon (Si), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), silver (Ag), sodium (Na), potassium (K), calcium (Ca), yttrium (Y), tantalum (Ta), hafnium (Hf), barium (Ba), vanadium (V), strontium (Sr), tellurium (Te), lanthanum (La), or a combination thereof. The first metal material may include, for example, at least one of Au, Pt, Pd, Si, Ag, Al, Bi, Sn, or Zn.

The first metal material may include a Li—Ag alloy, a Li—Au alloy, a Li—Al alloy, a Li—Sn alloy, a Li—In alloy, a Li—Zn alloy, a Li—Ge alloy, a Li—Si alloy, a Li—Sb alloy, a Li—Bi alloy, a Li—Ga alloy, a Li—Na alloy, a Li—K alloy, a Li—Te alloy, a Li—Mg alloy, a Li—Mo alloy, a Li—Sn—Bi alloy, a Li—Sn—Ag alloy, a Li—Sn—Na alloy, a Li—Sn—K alloy, a Li—Sn—Ca alloy, a Li—Te—Ag alloy, a Li—Sb—Ag alloy, a Li—Sn—Sb alloy, a Li—Sn—V alloy, a Li—Sn—Ni alloy, a Li—Sn—Cu alloy, a Li—Sn—Zn alloy, a Li—Sn—Ga alloy, a Li—Sn—Ge alloy, a Li—Sn—Sr alloy, a Li—Sn—Y alloy, a Li—Sn—Ba alloy, a Li—Sn—Au alloy, a Li—Sn—La alloy, a Li—Al—Ga alloy, a Li—Mg—Sn alloy, a Li—Mg—Al alloy, a Li—Mg—Si alloy, a Li—Mg—Zn alloy, a Li—Mg—Ga alloy, a Li—Mg—Ag alloy, or a combination thereof.

The interlayer may include a carbon-containing anode active material and a second metal material. Here, the second metal material may include a composite of a second metal, a metalloid, or a combination thereof.

A content of the second metal, the metalloid, or the combination thereof in the composite may be about 0.1 parts by weight to about 95 parts by weight, about 1 part by weight to about 95 parts by weight, about 5 parts by weight to about 90 parts by weight, about 10 parts by weight to about 85 parts by weight, or about 15 parts by weight to about 70 parts by weight with respect to 100 parts by weight of the composite.

A particle size of the second metal material in the interlayer may be about 0.1 nm to about 200 nm. When the particle size of the second metal material in the interlayer is in such a range, the interfacial resistance between the solid electrolyte and the anode may be reduced.

Due to high electronic conductivity, the interlayer may prevent a phenomenon in which electrons are concentrated on protrusions of the MIEC structure, may induce electrons to be uniformly distributed, and may not serve as a resistance film, thereby preventing the deterioration of high-rate characteristics. There may be an effect of suppressing the formation of lithium dendrites through the current dispersion in the protrusions of the MIEC structure. The interlayer may serve as a protective layer which, even when lithium exceeds the support capacity of the MIEC structure due to overcharge, prevents lithium metal from coming into direct contact with the solid electrolyte. Lithium precipitated after passing through the interlayer may be induced to be precipitated into the MIEC structure with a vertical nanotubular shape, thereby effectively preventing deterioration due to a change in cell thickness or generation of internal pressure.

A cell thickness change ratio of the solid secondary battery may be 20% or less or about 5% to about 20% or about 5% to about 10%. An amount of change in internal stress of the solid secondary battery may be 0.5 megapascals (MPa) or less or about 0.001 MPa to about 0.5 MPa or about 0.001 MPa to about 0.4 MPa.

The interlayer may include a carbon-containing material capable of reacting with lithium; lithium; a mixture of i) a carbon-containing material and ii) at least one of a second metal or a metalloid; a composite of i) a carbon-containing material and ii) at least one of a second metal or a metalloid; or a combination thereof.

The carbon-containing material may serve as a buffer layer, which may alleviate volume expansion due to lithium precipitation and desorption during charging or discharging, and may include, for example, amorphous carbon. Examples of the amorphous carbon may include carbon black (CB), acetylene black (AB), furnace black (FB), Ketjen black (KB), graphene, carbon nanotubes, carbon nanofibers, and the like, but one or more embodiments are not necessarily limited thereto. Any material may be used as long as the material may be classified as amorphous carbon in the art.

At least one of the second metal or the metalloid may include at least one of tin (Sn), indium (In), silicon (Si), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), molybdenum (Mo), silver (Ag), sodium (Na), potassium (K), calcium (Ca), yttrium (Y), tantalum (Ta), hafnium (Hf), barium (Ba), vanadium (V), strontium (Sr), tellurium (Te), or lanthanum (La), but one or more embodiments are not necessarily limited thereto. Any material may be used as long as the material may be used as a metal anode active material that forms an alloy or compound with lithium in the art.

The interlayer may include one type of anode active material selected from a carbon-containing material and a metal or metalloid anode active material or may include a mixture of a plurality of different anode active materials. For example, the interlayer may include only amorphous carbon or may include at least one metal or metalloid of tin (Sn), indium (In), silicon (Si), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), molybdenum (Mo), silver (Ag), sodium (Na), potassium (K), calcium (Ca), yttrium (Y), tantalum (Ta), hafnium (Hf), barium (Ba), vanadium (V), strontium (Sr), tellurium (Te), or lanthanum (La). Alternatively, the interlayer may include a composite of at least one metal or metalloid anode active material selected from tin (Sn), indium (In), silicon (Si), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), molybdenum (Mo), silver (Ag), sodium (Na), potassium (K), calcium (Ca), yttrium (Y), tantalum (Ta), hafnium (Hf), barium (Ba), vanadium (V), strontium (Sr), tellurium (Te), or lanthanum (La). A composite ratio of amorphous carbon to a metal or metalloid anode active material such as silver may be a weight ratio and may be, for example, about 10:1 to about 1:2, about 5:1 to about 1:1, or about 4:1 to about 2:1, but one or more embodiments are not necessarily limited to such a range. The composite ratio may be selected according to the required characteristics of a solid secondary battery. Since the interlayer has such a composition, the cycle characteristics of a solid secondary battery may be further improved.

The interlayer may include, for example, a mixture of first particles including amorphous carbon and second particles including a metal or metalloid. The mixture may be a simple resultant mixture of the first particles and the second particles or a resultant mixture in which the first particles and the second particles are physically bound by a binder. The metal or metalloid may include at least one of tin (Sn), indium (In), silicon (Si), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), molybdenum (Mo), silver (Ag), sodium (Na), potassium (K), calcium (Ca), yttrium (Y), bismuth (Bi), tantalum (Ta), hafnium (Hf), gold (Au), barium (Ba), vanadium (V), strontium (Sr), tellurium (Te), or lanthanum (La). Alternatively, the metalloid may be a semiconductor. A content of the second particles may be about 8 weight percent (wt %) to about 60 wt %, about 10 wt % to about 50 wt %, about 15 wt % to about 40 wt %, or 20 wt % to about 30 wt % with respect to the total weight of the mixture. The second particles may have a content in such a range, and thus, for example, the cycle characteristics of a solid secondary battery may be further improved.

The interlayer may include i) a composite of first particles including amorphous carbon and second particles including a metal or metalloid, or ii) a mixture of first particles including amorphous carbon and second particles including a metal or metalloid. A content of the second particles in the composite may be about 1 wt % to about 60 wt % with respect to the total weight of the composite. A content of the second particles in the mixture may be about 1 wt % to about 60 wt % with respect to the total weight of the mixture.

The interlayer may contain, for example, a mixture of a carbon-containing material and silver (Ag), or a composite of a carbon-containing material and silver (Ag).

The interlayer may include a carbon-containing material, graphite, gold, silver, nickel, platinum, molybdenum, tungsten, stainless teel, lithium-Ag, carbon-Ag, or a combination thereof.

A thickness of the interlayer may be 20 μm or less or about 1 μm to about 20 μm, about 1 μm to about 10 μm, or about 1 μm to about 9 μm. When the thickness of the interlayer is in such a range, lithium may be effectively assisted in being precipitated in recessed portions of the solid electrolyte, a short circuit of a solid secondary battery may be suppressed, and cycle characteristics thereof may be improved.

A volume of the open pore may be determined according to a capacity per unit area of the cathode.

Lithium may be precipitated as lithium metal and may also be partially present in the form of a lithium alloy.

According to an embodiment, the precipitated lithium may be present in a lithium metal state.

When the sub-assembly according to an embodiment is used, since there is no need to use a buffering agent which, due to a significant change in thickness of an anode-free solid secondary battery using a precipitation-type anode according to a related art, is typically required to manufacture a battery module, the energy density of a solid secondary battery may be further increased. Pressure issues caused by precipitation of lithium formed in a cell and a battery may be resolved. In addition, due to lithium precipitation from the rapid movement of lithium ions within the interlayer according to an embodiment, high-rate characteristics may be improved. Finally, due to a stress-free anode, that is, zero stress, a buffering agent may be used in an auxiliary pressure control method, and the buffering agent may not be used, thereby increasing energy density.

In the present specification, when a thickness of each layer is not uniform, the thickness may be defined as an average thickness obtained by calculating an average value.

For example, the interlayer may contain a lithium-free composite during battery assembly, but the lithium-free composite may be converted into a lithium-containing composite after pressing and/or battery charging.

By removing a change in thickness due to electrodeposition/desorption of lithium during charging or discharging, the solid secondary battery according to an embodiment may have improved lifespan characteristics, optimized total battery thickness, and high energy density without the need to apply a buffer layer (gasket) according to a related art. In addition, the movement of lithium ions through the interlayer may be maximized, thereby improving high-rate characteristics. As a result, the excellent energy density characteristics of the solid secondary battery according to an embodiment may be implemented.

According to another embodiment, in some cases, an anode current collector, an interlayer, or a region therebetween may be Li metal-free regions not including lithium (Li) metal in an initial state of a battery assembly of the solid secondary battery or in a fully discharged state.

### Cathode

FIG. 1E is a cross-sectional view of a solid secondary battery 100 according to an embodiment. Referring to FIG. 1E, the solid secondary battery may be a secondary battery that uses a solid electrolyte as an electrolyte. The solid secondary battery may include the cathode 10 and the anode-solid electrolyte sub-assembly 26.

The cathode 10 may include the cathode current collector 11 and the cathode active material layer 12.

The cathode current collector 11 may be provided as a plate, foil, or the like including, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

The cathode active material layer 12 may include, for example, a cathode active material.

The cathode active material may be a cathode active material capable of reversibly intercalating and deintercalating lithium ions. Examples of the cathode active material may include a lithium transition metal oxide such as lithium cobalt oxide (LCO), lithium nickel oxide, lithium nickel cobalt oxide, lithium nickel cobalt aluminum oxide (NCA), lithium nickel cobalt manganate (NCM), lithium manganate, or lithium iron phosphate oxide, nickel sulfide, copper sulfide, lithium sulfide, iron oxide, vanadium oxide, or the like, but one or more embodiments are not necessarily limited thereto. Any material may be used as long as the material may be used as a cathode active material in the art. Each of cathode active materials may be used alone, or a mixture of two or more types thereof may be used.

For example, the cathode active material may include a compound represented by any one of formulas of LiₐA_{1-b}B′_{b}D₂, wherein 0.90≤a≤1 and 0≤b≤0.5; LiₐE_{1-b}B′_{b}O_{2-c}D_{c}, wherein 0.90≤a≤1, 0≤b≤0.5, and 0≤c≤0.05; LiE_{2-b}B′b_{4-c}D_{c}; wherein 0≤b≤0.5 and 0≤c≤0.05; LiₐNi_{1-b-c}CO_{b}B′_{c}Dₐ, wherein 0.90≤a≤1, 0sb≤0.5, 0≤c≤0.05, and 0<α≤2; LiₐNi_{1-b-c}CO_{b}B′CO_{2-α}F′_{α}, wherein 0.90≤a≤1, 0≤b≤0.5, 0<c≤0.05, and 0<α<2; LiₐNi_{1-b-c}CO_{b}B′CO₂₋ₐF′₂, wherein 0.90≤a≤1, 0≤b≤0.5, 0≤c≤0.05, and 0<α<2; LiₐNi_{1-b-c}Mn_{b}B′_{c}Dₐ, wherein 0.90≤a≤1, 0≤b≤0.5, 0≤c<0.05, and 0<a≤2; LiₐNi_{1-b-c}Mn_{b}B′CO_{2-α}F′_{α}, wherein 0.90≤a≤1, 0≤b≤0.5, 0≤c≤0.05, and 0<α<2; LiₐNi_{1-b-c}Mn_{b}B′CO_{2-α}F′₂, wherein 0.90≤a≤1, 0≤b≤0.5, 0≤c≤0.05, and 0<α<2; LiₐNi_{b}E_{c}GaO₂, wherein 0.90≤a≤1, 0≤b≤0.9, and 0≤c≤0.5, and 0.001≤d≤0.1; LiₐNi_{b}COMnₐGeO₂, wherein 0.90≤a≤1, 0≤b≤0.9, 0≤c≤0.5, 0≤d<0.5, and 0.001≤e≤0.1; LiₐNiG_{b}O₂, wherein 0.90≤a≤1 and 0.001≤b≤0.1; LiₐCoG_{b}O₂, wherein 0.90≤a≤1 and 0.001≤b≤0.1; LiₐMnG_{b}O₂, wherein 0.90≤a≤1 and 0.001≤b≤0.1; LiₐMn₂G_{b}O₄, wherein 0.90≤a≤1 and 0.001 sb≤0.1; QO₂; QS₂; LiQS₂; V₂O₅; LiV₂O₅; LiVO₂; LiNiVO₄; Li_{(3-f)}J₂(PO₄)₃, wherein 0≤f≤2; Li_{(3-f)}Fe₂(PO₄)₃, wherein 0≤f≤2; and LiFePO₄. In such compounds, A may be Ni, Co, Mn, or a combination thereof, B′ may be Al, Ni, Co, Mn, Cr, Fe, Mg, Sr, V, a rare earth element, or a combination thereof, D may be O, F, S, P, or a combination thereof, E may be Co, Mn, or a combination thereof, F′ may be F, S, P, or a combination thereof, G may be Al, Cr, Mn, Fe, Mg, La, Ce, Sr, V, or a combination thereof, Q may be Ti, Mo, Mn, or a combination thereof, I′ may be Cr, V, Fe, Sc, Y, or a combination thereof, and J may be V, Cr, Mn, Co, Ni, Cu, or a combination thereof. A compound in which a coating layer is added to a surface of such a compound may also be used, and a mixture of the above compound and a compound in which a coating layer is added may also be used. The coating layer added to the surface of such a compound includes, for example, a coating element compound of an oxide, hydroxide, oxyhydroxide of the coating element, oxycarbonate of the coating element, or hydroxycarbonate of the coating element. A compound constituting the coating layer may be amorphous or crystalline. The coating element included in the coating layer may include Mg, Al, Co, K, Na, Ca, Si, Ti, V, Sn, Ge, Ga, B, As, Zr, or a mixture thereof. A method of forming a coating layer may be selected within a range that does not adversely affect the physical properties of a cathode active material. A coating method may include, for example, spray coating, dipping, or the like. A specific coating method may be well understood by those skilled in the art, and thus a detailed description thereof will be omitted.

The cathode active material may include, for example, a lithium salt of a lithium transition metal oxide having a layered rock salt type structure among the above-described lithium transition metal oxides. The “layered rock salt type structure” may be, for example, a structure in which oxygen layers and metal atom layers are alternatively arrayed regularly in a direction of a axis of a cubic rock salt type structure, and thus the respective atom layers form a two-dimensional plane. The “cubic rock salt type structure” may refer to a NaCl type structure that is a type of a crystal structure, specifically a structure in which face-centered cubic (fcc) lattices respectively formed by cations and anions are shifted by half a ridge of each unit lattice. The lithium transition metal oxide having the layered rock salt type structure may include, for example, a ternary lithium transition metal oxide such as LiNiₓCo_{y}Al_{z}O₂ (NCA) or LiNiₓCo_{y}Mn_{z}O₂ (NCM), wherein 0<x<1, 0<y<1, 0<z<1, and x+y+Z=1. When the cathode active material includes the ternary lithium transition metal oxide having a layered rock salt type structure, the energy density and thermal stability of a solid secondary battery may be further improved.

The cathode active material may be covered with the coating layer as described above. As the coating layer, any layer may be used as long as the layer is known as a coating layer for a cathode active material of a solid secondary battery. The coating layer may include, for example, Li₂O—ZrO₂ or the like.

When the cathode active material includes, for example, nickel (Ni) for a ternary lithium transition metal oxide such as NCA or NCM, the capacity density of a solid secondary battery may be increased, thereby reducing metal elution from the cathode active material in a charged state. As a result, the cycle characteristics of a solid secondary battery may be improved.

A shape of the cathode active material may be, for example, a particle shape such as a spherical shape or an elliptical spherical shape. A particle diameter of the cathode active material is not particularly limited and is within a range applicable to a cathode active material of a solid secondary battery according to a related art. A content of the cathode active material in the cathode 10 is also not particularly limited and is within a range applicable to the cathode 10 of a solid secondary battery according to a related art.

In addition to the above-described cathode active material, the cathode 10 may further include additives such as a conductive agent, a binder, a filler, a dispersant, and an ion-conductive adjuvant. Such a conductive agent may include, for example, graphite, CB, AB, KB, a carbon fiber, a metal powder, or the like. The binder may include, for example, styrene butadiene rubber (SBR), polytetrafluoroethylene, polyvinylidene fluoride, polyethylene, or the like. As a coating agent, a dispersant, an ion-conductive adjuvant, and the like that may be mixed into the cathode 10, known materials generally used in electrodes of a solid secondary battery may be used.

The cathode 10 may further include a solid electrolyte. The solid electrolyte included in the cathode 10 may be similar to or different from a solid electrolyte included in the solid electrolyte 30. The solid electrolyte may be as defined in a part of the solid electrolyte 30.

Alternatively, the cathode 10 may be impregnated, for example, with a liquid electrolyte. The liquid electrolyte may include a lithium salt and at least one of an ionic liquid and a polymer ionic liquid. The liquid electrolyte may be non-volatile. The ionic liquid may refer to a salt in a liquid state at room temperature or a room-temperature molten salt that has a melting point at room temperature or less and consists of only ions. The ionic liquid may include one selected from compounds including a) one cation selected of an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-base cation, a phosphonium-based cation, a sulfonium-based cation, a triazol-based cation, or a mixture thereof, and b) at least one anion of BF₄, PF₆, AsF₆, SbF₆, AlCl₄, HSO₄, ClO₄, CH₃SO₃, CF₃CO₂, Cl, Br, I, SO₄, CF₃SO₃, (FSO₂)₂N, (C₂F₅SO₂)₂N—, (C₂F₅SO₂)(CF₃SO₂)N, or (CF₃SO₂)₂N. The ionic liquid may include, for example, at least one of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)imide, or 1-ethyl-3-methylimidazolium bis(trifluoromethylsulfonyl)imide. The polymer ionic liquid may include a repeating unit including a) one cation of an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-base cation, a phosphonium-based cation, a sulfonium-based cation, a triazol-based cation, or a mixture thereof; and b) at least one anion of BF₄, PF₆, AsF₆, SbF₆, AlCl₄—, HSO₄—, ClO₄—, CH₃SO₃—, CF₃CO₂—, (CF₃SO₂)₂N—, (FSO₂)₂N—, Cl—, Br—, I—, SO₄—, CF₃SO₃—, (C₂F₅SO₂)₂N—, (C₂F₅SO₂)(CF₃SO₂)N—, NO₃—, Al₂Cl₇—, (CF₃SO₂)₃C—, (CF₃)₂PF₄—, (CF₃)₃PF₃—, (CF₃)₄PF₂—, (CF₃)₅ PF—, (CF₃)₆P—, SF₅CF₂SO₃—, SF₅CHFCF₂SO₃—, CF₃CF₂(CF₃)₂CO—, CF₃SO₂)₂CH—, (SF₅)₃C—, or (O(CF₃)₂C₂(CF₃)₂O)₂PO—. As the lithium salt, any material may be used as long as the material may be used as a lithium salt in the art. The lithium salt may include, for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN, LiN(CₓF₂ₓ₊₁SO₂)(C_{y}F_{2y+1}SO₂), wherein x and y are each a natural number, LiCl, LiI, or a mixture thereof. A concentration of the lithium salt included in the liquid electrolyte may be about 0.1 moles per liter (M) to about 5 M. A content of the liquid electrolyte impregnated into the cathode 10 may be about 0 parts by weight to about 100 parts by weight, about 0 parts by weight to about 50 parts by weight, about 0 parts by weight to about 30 parts by weight, about 0 parts by weight to about 20 parts by weight, about 0 parts by weight to about 10 parts by weight, or about 0 parts by weight to about 5 parts by weight with respect to 100 parts by weight of the cathode active material layer 12 that does not include a liquid electrolyte.

### Anode-Solid Electrolyte Sub-Assembly

The anode-solid electrolyte sub-assembly 26 may include an anode current collector 21, an interlayer 23, a MIEC structure 22 having a plurality of pores 24, and the solid electrolyte 30.

The solid electrolyte 30 may be disposed to face the cathode 10.

The solid electrolyte 30 may be an oxide solid electrolyte, a sulfide solid electrolyte, a polymer electrolyte, or a combination thereof.

The oxide solid electrolyte may be at least one of Li_{1+x+y}Alₓ Ti₂₋ₓSi_{y}P_{3-y}O₁₂, wherein 0<x<2 and 0≤y<3, Li₃PO₄, LiₓTi_{y} (PO₄)₃, wherein 0<x<2 and 0<y<3, LiₓAl_{y}Ti_{z} (PO₄) 3, wherein 0<x<2, 0<y<1, and 0<z<3, Li₁+x+y (AlₚGa₁₋ₚ)ₓ(Ti_{q}Ge_{1-q})₂₋ₓSi_{y}P_{3-y}O₁₂, wherein 0≤x≤1, 0≤y≤1, 0≤p<1, and 0≤q≤1, LiₓLa_{y}TiO₃, wherein 0<x<2 and 0<y<3, Li₂O, LiOH, Li₂CO₃, LiAlO₂, Li₂O—Al₂O₃—SiO₂—P₂O₅—TiO₂—GeO₂, or Li₃₊ₓLa₃M₂O₁₂, wherein M is Te, Nb, Zr, or a combination thereof, and x is an integer from 1 to 10. The solid electrolyte 30 may be prepared through sintering or the like.

The oxide solid electrolyte may be, for example, a garnet-type solid electrolyte.

A non-limiting example of the garnet-type solid electrolyte may include an oxide represented by Formula 1.

(LiₓM1_{y})(M2)_{3-δ}(M3)_{2-ω}O_{12-z}X_{z} Formula 1

In Formula 1, 6≤x≤8, 0≤y<2,−0.2<δ<0.2,−0.2≤ω≤0.2, 0≤z≤2, M1 may be a monovalent cation, a divalent cation, a trivalent cation, or a combination thereof, M2 may be a monovalent cation, a divalent cation, a trivalent cation, or a combination thereof, M3 may be a monovalent cation, a divalent cation, a trivalent cation, a tetravalent cation, a pentavalent cation, a hexavalent cation, or a combination thereof, and X may be a monovalent anion, a divalent anion, a trivalent anion, or a combination thereof.

In Formula 1, examples of the monovalent cation may include Na, K, Rb, Cs, H, Fr, and the like, and examples of the divalent cation may include Mg, Ca, Ba, Sr, and the like. Examples of the trivalent cation may include In, Sc, Cr, Au, B, Al, Ga, and the like, and examples of the tetravalent cation may include Sn, Ti, Mn, Ir, Ru, Pd, Mo, Hf, Ge, V, Si, and the like. Examples of the pentavalent cation may include Nb, Ta, Sb, V, P, and the like.

M1 may be, for example, hydrogen (H), iron (Fe), gallium (Ga), aluminum (Al), boron (B), beryllium (Be), or a combination thereof. M2 may be lanthanum (La), barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof, and M3 may be zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al), or a combination thereof.

In Formula 1, a monovalent anion used as X may be a halogen atom, a pseudohalogen, or a combination thereof, a divalent anion used as X may be S² or Se², and a trivalent anion used as X may be, for example, N³.

In Formula 1, 6.6≤x≤8, 6.7<x≤7.5, or 6.8≤x≤7.1.

A non-limiting example of the garnet-type solid electrolyte may include an oxide represented by Formula 2.

(LiₓM1_{y})(Laₐ₁M2ₐ₂)_{3-δ}(Zr_{b1}M3_{b2})_{2-ω}O_{12-z}X_{z} Formula 2

In Formula 2, M1 may be hydrogen (H), iron (Fe), gallium (Ga), aluminum (Al), boron (B), beryllium (Be), or a combination thereof, M2 may be barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof, M3 may be hafnium (Hf), tin (Sn), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al), or a combination thereof, 6≤x≤8, 0≤y<2,-0.2≤δ<0.2,−0.2≤ω≤0.2, 0<z≤2, a1+a2=1, 0<a1<1,0<a2<1,b1+b2−1, 0<b1<1, 0≤b2<1, and X may be a monovalent anion, a divalent anion, a trivalent anion, or a combination thereof.

In Formula 2, a monovalent anion used as X may be a halogen atom, a pseudohalogen, or a combination thereof, a divalent anion used as X may be S²⁻ or Se²⁻, and a trivalent anion used as X may be, for example, N³⁻.

In Formula 2, 6.6≤x≤8, 6.7≤x≤7.5, or 6.8≤x≤7.1.

In the present specification, a “pseudohalogen” may be a molecule including two or more electronegative atoms similar to a halogen in a free state and may generate anions similar to halide ions. Examples of the pseudohalogen may include cyanide, cyanate, thiocyanate, azide, or a combination thereof.

The halogen atom may include, for example, iodine (I), chlorine (Cl), bromine (Br), fluorine (F), or a combination thereof, and the pseudohalogen may include, for example, cyanide, cyanate, thiocyanate, azide, or a combination thereof.

The trivalent anion may be, for example, N³⁻.

In Formula 2, M1 may be Al, Ga, In, Si, Ge, Sn, Sb, Bi, Sc, Y, Ti, Hf, V, Nb, Ta, W, or a combination thereof.

According to another embodiment, the garnet-type solid electrolyte may be an oxide represented by Formula 3 below.

Li₃₊ₓLa₃Zr₂₋ₐMₐO₁₂ Formula 3

In Formula 3, M may be Al, Ga, In, Si, Ge, Sn, Sb, Bi, Sc, Y, Ti, Hf, V, Nb, Ta, W, or a combination thereof, and x may be a number from 1 to 10, and 0≤a<2.

Examples of the garnet-type solid electrolyte may include Li₇La₃Zr₂O₁₂, Li_{6.5}La₃Zr_{1.5}Ta_{0.5}O₁₂, and the like.

When an oxide solid electrolyte is used, at an anode, an additional lithium metal layer may be further formed for prelithiation. Here, the lithium metal layer may have a ring shape to surround the anode.

Alternatively, the solid electrolyte may be, for example, a sulfide solid electrolyte. The sulfide solid electrolyte may include, for example, at least one of Li₂S—P₂S₅, Li₂S—P₂S₅—LiX, wherein X is a halogen element, Li₂S—P₂S₅—Li₂O, Li₂S—P₂S₅—Li₂O—LiI, Li₂S—SiS₂, Li₂S—SiS₂—LiI, Li₇S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, wherein m and n are each a positive number and Z is one of Ge, Zn, and Ga, Li₂S—GeS₂, Li₂S—SiS₂—Li₂PO₄, Li₂S—SiS₂—LiₚMO_{q}, wherein p and q are each a positive number and M is one of P, Si, Ge, B, Al, Ga, and In, Li₇₋ₓPS₆₋ₓClₓ, wherein 0≤x≤2, Li₇₋ₓPS₆₋ₓBrₓ, wherein 0<x≤2, or Li₇₋ₓPS₆₋ₓIₓ, wherein 0<x≤2. The sulfide solid electrolyte may be prepared by treating a starting material such as Li₂S or P₂S₅ through melting quenching, mechanical milling, or the like. In addition, after such treating, heat treatment may be performed. The sulfide solid electrolyte may be in an amorphous state, a crystalline state, or a mixture state thereof.

In addition, the sulfide solid electrolyte may be, for example, a material that includes at least sulfur(S), phosphorus (P), and lithium (Li) as constituent elements among materials of the above-described sulfide-based solid electrolyte. For example, the sulfide solid electrolyte may be a material including Li₂S—P₂S₅. When the material including Li₂S—P₂S₅ is used as a sulfide solid electrolyte material, a mixing molar ratio of Li₂S to P₂S₅, for example, Li₂S:P₂S₅ may be about 50:50 to about 90:10.

The sulfide-based solid electrolyte may contain a compound represented by Formula 4.

LiₐM1ₓPS_{y}M2_{z}M3_{w} Formula 4

In Formula 4, M1 may be at least one metal element selected from Groups 1 to 15 of the periodic table of the elements other than Li, M2 may be at least one element selected from Group 17 of the periodic table of the elements, M3 may be SOₙ, 4≤a≤8, 0≤x<1, 3≤y≤7, 0<z≤5, 0≤w<2, and 1.5≤n≤5.

“Group” refers to a group of the periodic table of the elements according to the IUPAC Groups 1−18 group classification system.

In Formula 4, 0<<5, 0<z≤4, 0<z≤3, 0<z≤2, 0.2≤z≤1.8, 0.5≤z≤1.8, 1.0≤z≤1.8, or 1.0≤z≤1.5.

In Formula 1, 5≤a≤8, 0≤x≤0.7, 4≤y≤7, 0<z≤2, and 0≤w≤0.5; for example, 5≤a≤7, 0≤x≤0.5, 4≤y≤6, 0<z≤2, and 0≤w≤0.2; for example, 5.5≤a≤7, 0≤x≤0.3, 4.5≤y≤6, 0.2≤z≤1.8, and 0≤w≤0.1; and 5.5≤a≤6, 0≤x<0.05, 4.5≤y≤5, 1.0≤z≤1.5, and 0≤w≤0.1.

In the compound represented by Formula 4, for example, M1 may include Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof. M1 may be, for example, a monovalent cation or a divalent cation.

In the compound represented by Formula 4, for example, M2 may include F, Cl, Br, I, or a combination thereof. M2 may be, for example, a monovalent anion.

In the compound represented by Formula 4, for example, SOₙ of M3 may be S₄O₆, S₃O₆, S₂O₃, S₂O₄, S₂O₅, S₂O₆, S₂O₇, S₂O₈, SO₄, SO₅, or a combination thereof. SOₙ may be, for example, a divalent anion. SOₙ²⁻ may be, for example, S₄O₆², S₃O₆², S₂O₃²⁻, S₂O₄²⁻, S₂O₅²⁻, S₂O₆²⁻, S₂O₇²⁻, S₂O₈²⁻, SO₄²⁻, SO₅²⁻, or a combination thereof.

The compound represented by Formula 4 may be, for example, a compound selected from compounds represented by Formula 4a and Formula 4b.

LiₐPS_{y}M2_{z} Formula 4a

In Formula 4a, M2 may be at least one element selected from Group 17 of the periodic table of the elements, 4≤a≤8, 3≤y≤7, and 0<z≤5.

LiₐPS_{y}M2_{z}M3_{w} Formula 4b

In Formula 4a, M2 may be at least one element selected from Group 17 of the periodic table of the elements, M3 may be SOₙ, 4<a≤8, 3≤y≤7, 0<z≤5, 0<w<2, and 1.5≤n≤5.

In Formula 4a and Formula 4b, 0<z≤5, 0<z≤4, 0<z≤3, 0<z≤2, 0.2≤z≤1.8, 0.5≤z≤1.8, 1.0≤z≤1.8, or 1.0≤z≤1.5. In Formula 4a and Formula 4b, for example, 5≤a≤8, 4≤y≤7, 0<z≤2, and 0≤ω<0.5; 5.5≤a≤7, 4.5≤y≤6, 0.2≤z≤1.8, and 0≤ω≤0.1, 0.5≤z≤1.8, or 1.0≤z≤1.8.

The compound represented by Formula 4 may be, for example, a compound represented by Formula 5 below.

Li_{7-mxv-z}M4ᵥPS_{6-z}M5_{z1}M6_{z2}

In Formula 5, M4 may be Na, K, Mg, Ag, Cu, Hf, In, Ti, Pb, Sb, Fe, Zr, Zn, Cr, B, Sn, Ge, Si, Ta, Nb, V, Ga, Al, As, or a combination thereof; m may be an oxidation number of M4; M5 and M6 may each independently be F, Cl, Br, or 1; 0<v<0.7; 0<z1<2, 0≤z2<1; 0<z<2; z=z1+_{z2}; and 1≤m≤2.

For example, 0<v≤0.7, 0<z1<2, 0≤z2≤0.5, 0<z<2, and z=z1+_{z2}. For example, 0<v≤0.5, 0<z1<2, 0≤z2≤0.5, 0<z<2, and z=z1+_{z2}. For example, 0<v≤0.3, 0<z1≤1.5, 0≤z2≤0.5, 0.2≤z≤1.8, and z=z1+_{z2}. For example, 0<v≤0.1, 0<z1≤1.5, 0≤z2≤0.5, 0.5≤z≤1.8, and z=z1+_{z2}. For example, 0<v≤0.05, 0<z1<1.5, 0≤z2<0.2, 1.0≤z≤1.8, and z=z1+_{z2}. M4 may be, for example, one type of metal element or two types of metal elements.

The compound represented by Formula 5 may include, for example, one type of halogen element or two types of halogen elements.

The compound represented by Formula 4 may be, for example, a solid ion conductor compound represented by one of Formulas 5a to 5f:

Li_{7-z}PS_{6-z}M5_{z1}M6_{z2}, Formula 5a

Li_{7-v-z}NaᵥPS_{6-z}M5_{z1}M6_{z2}, Formula 5b

Li_{7-v-z}KᵥPS_{6-z}M5_{z1}M6_{z2}, Formula 5c

Li_{7-v-z}CuᵥPS_{6-z}M5_{z1}M6_{z2}, Formula 5d

Li_{7-v-z}MgᵥPS_{6-z}M5_{z1}M6_{z2}, and Formula 5e

Li_{7-v-z}AgᵥPS_{6-z}M5_{z1}M6_{z2}.

In Formulas 5a to 5f, M5 and M6 may each independently be F, Cl, Br, or I, 0<v≤0.7, 0<z1<2, 0<z2<1, 0<z<2, and z=z1+_{z2}.

In Formulas 5a to 5f, independently of each other, for example 0<v≤0.7, 0<z1<2, 0≤z2≤0.5, 0<z<2, and z=z1+z2; 0<v≤0.5, 0<z1<2, 0≤z2<0.5, 0<z<2, and z=z1+z2; 0<v≤0.3, 0<z1≤1.5, 0≤z2<0.5, 0.2≤z≤1.8, and z=z1+z2; 0<v≤0.05, 0<z1≤1.5, 0≤z2≤0.2, 1.0≤z≤1.8, and z=z1+_{z2}; and for example, 0<v≤0.05, 0<z1≤1.5, 0≤z2≤0.2, 1.0≤z≤1.5, and z=z1+_{z2}. In Formula 5a, v=0.

The compound represented by Formula 4 may be, for example, a compound represented by one of the following formulas:
Li_{7-z}PS_{6-z}F_{z1}, Li_{7-z}PS_{6-z}Cl_{z1}, Li_{7-z}PS_{6-z}Br_{z1}, Li_{7-z}PS_{6-z}I_{z1}, Li_{7-z}PS_{6-z}F_{z1}Cl_{z2}, Li_{7-z}PS_{6-z}F_{z1}Br_{z2}, Li_{7-z}PS_{6-z}F_{z1}I_{z2}, Li_{7-z}PS_{6-z}Cl_{z1}Br_{z2}, Li_{7-z}PS_{6-z}Cl_{z1}I_{z2}, Li_{7-z}PS_{6-z}Cl_{z1}F_{z2}, Li_{7-z}PS_{6-z}Br_{z1}I_{z2}, Li_{7-z}PS_{6-z}Br_{z1}F_{z2}, Li_{7-z}PS_{6-z}Br_{z1}Cl_{z2}, Li_{7-z}PS_{6-z}I_{z1}F_{z2}, Li_{7-z}PS_{6-z}I_{z1}Cl_{z2}, Li_{7-z}PS_{6-z}I_{z1}Br_{z2}, Li_{7-v-z}NaᵥPS_{6-z}F_{z1}, Li_{7-v-z}NaᵥPS_{6-z}Cl_{z1}, Li_{7-v-z}NaᵥPS_{6-z}Br_{z1}, Li_{7-v-z}NaᵥPS_{6-z}I_{z1}, Li_{7-v-z}NaᵥPS_{6-z}F_{z1}Cl_{z2}, Li_{7-v-z}NaᵥPS_{6-z}F_{z1}Br_{z2}, Li_{7-v-z}NaᵥPS_{6-z}F_{z1}I_{z2}, Li_{7-v-z}NaᵥPS_{6-z}Cl_{z1}Br_{z2}, Li_{7-v-z}NaᵥPS_{6-z}Cl_{z1}I_{z2}, Li_{7-v-z}NaᵥPS_{6-z}Cl_{z1}F_{z2}, Li_{7-v-z}NaᵥPS_{6-z}Br_{z1}I_{z2}, Li_{7-v-z}NaᵥPS_{6-z}Br_{z1}F_{z2}, Li_{7-v-z}NaᵥPS_{6-z}Br_{z1}Cl_{z2}, Li_{7-v-z}NaᵥPS_{6-z}I_{z1}F_{z2}, Li_{7-v-z}NaᵥPS_{6-z}I_{z1}Cl_{z2}, Li_{7-v-z}NaᵥPS_{6-z}I_{z1}Brz₂, Li_{7-v-z}KᵥPS_{6-z}F_{z1}, Li_{7-v-z}KᵥPS_{6-z}Cl_{z1}, Li_{7-v-z}KᵥPS_{6-z}Br_{z1}, Li_{7-v-z}KᵥPS_{6-z}I_{z1},
Li_{7-v-z}KᵥPS_{6-z}F_{z1}Cl_{z2}, Li_{7-v-z}KᵥPS_{6-z}F_{z1}Br_{z2}, Li_{7-v-z}KᵥPS_{6-z}F_{z1}I_{z2}, Li_{7-v-z}KᵥPS_{6-z}Cl_{z1}Br_{z2}, Li_{7-v-z}KᵥPS_{6-z}Cl_{z1}I_{z2}, Li_{7-v-z}KᵥPS_{6-z}Cl_{z1}F_{z2}, Li_{7-v-z}KᵥPS_{6-z}Br_{z1}I_{z2}, Li_{7-v-z}KᵥPS_{6-z}Br_{z1}F_{z2}, Li_{7-v-z}KᵥPS_{6-z}Br_{z1}Cl_{z2}, Li_{7-v-z}KᵥPS_{6-z}I_{z1}F_{z2}, Li_{7-v-z}KᵥPS_{6-z}I_{z1}Cl_{z2}, Li_{7-v-z}KᵥPS_{6-z}I_{z1} Br_{z2},
Li_{7-v-z}CuᵥPS_{6-z}F_{z1}, Li_{7-v-z}CuᵥPS_{6-z}Cl_{z1}, Li_{7-v-z}CuvPS_{6-z}Br_{z1}, Li_{7-v-z}CuvPS_{6-z}I_{z1}, Li_{7-v-z}CuᵥPS_{6-z}F_{z1}Cl_{z2}, Li_{7-v-z}CuᵥPS_{6-z}F_{z1}Br_{z2}, Li_{7-v-z}CuvPS_{6-z}F_{z1}I_{z2}, Li_{7-v-z}CuᵥPS_{6-z}Cl_{z1}Br_{z2}, Li_{z-v-z}CuᵥPS_{6-z}Cl_{z1}I_{z2}, Li_{7-v-z}CuᵥPS_{6-z}Cl_{z1}F_{z2}, Li_{7-v-z}CuᵥPS_{6-z}Br_{z1}I_{z2}, Li_{7-v-z}CuᵥPS_{6-z}Br_{z1}F_{z2}, Li_{7-v-z}CuᵥPS_{6-z}Br_{z1}Cl_{z2}, Li_{7-v-z}CuᵥPS_{6-z}I_{z1}F_{z2}, Li_{7-v-z}CuᵥPS_{6-z}I_{z1}Cl_{z2}, Li_{7-v-z}CuᵥPS_{6-z}I_{z1}Br_{z2},
Li_{7-2v-z}MgᵥPS_{6-z}F_{z1}, Li_{7-2v-z}MgᵥPS_{6-z}Cl_{z1}, Li_{7-2v-z}MgᵥPS_{6-z}Br_{z1}, Li_{7-2v-z}MgᵥPS_{6-z}I_{z1}, Li_{7-2v-z}MgᵥPS_{6-z}F_{z1}Cl_{z2}, Li_{7-2v-z}MgᵥPS_{6-z}F_{z1}Br_{z2}, Li_{7-2v-z}MgᵥPS_{6-z}F_{z1}I_{z2}, Li_{7-2v-z}MgᵥPS_{6-z}Cl_{z1}Br_{z2}, Li_{7-2v-z}MgᵥPS_{6-z}Cl_{z1}I_{z2}, Li_{7-2v-z}MgᵥPS_{6-z}Cl_{z1}F_{z2}, Li_{7-2v-z}MgᵥPS_{6-z}Br_{z1}I_{z2}, Li_{7-2v-z}MgᵥPS_{6-z}Br_{z1}F_{z2}, Li_{7-2v-z}MgᵥPS_{6-z}Br_{z1}Cl_{z2}, Li_{7-2v-z}MgᵥPS_{6-z}I_{z1}F_{z2}, L_{z}I_{z1}Cl_{z2}, Li_{7-2v-z}MgᵥPS_{6-z}I_{z1}Br_{z2},

Li_{7-v-z}AgᵥPS_{6-z}F_{z1}, Li_{7-v-z}AgᵥPS_{6-z}Cl_{z1}, Li_{7-v-z}AgᵥPS_{6-z}Br_{z1}, Li_{7-v-z}AgᵥPS_{6-z}I_{z1}, Li_{7-v-z}AgᵥPS_{6-z}F_{z1}Cl_{z2}, Li_{7-v-z}AgᵥPS_{6-z}F_{z1}Br_{z2}, Li_{7-v-z}AgᵥPS_{6-z}F_{z1}I_{z2}, Li_{7-v-z}AgᵥPS_{6-z}Cl_{z1}Br_{z2}, Li_{7-v-z}Ag_{y}PS_{6-z}Cl_{z1}I_{z2}, Li_{7-v-z}AgᵥPS_{6-z}Cl_{z1}F_{z2}, Li_{7-v-z}AgᵥPS_{6-z}Br_{z1}I_{z2}, Li_{7-v-z}AgᵥPS_{6-z}Br_{z1}F_{z2}, Li_{7-v-z}AgᵥPS_{6-z}Br_{z1}Cl_{z2}, Li_{7-v-z}AgᵥPS_{6-z}I_{z1}F_{z2}, Li_{7-v-z}AgᵥPS_{6-z}I_{z1}Cl_{z2}, and Li_{7-v-z}AgᵥPS_{6-z}I_{z1}Br_{z2}.

In the above formulas, independently of each other, 0<v≤0.7, 0<z1<2, 0<z2<1, 0<z<2, and z=z1+_{z2}; for example, 0<v≤0.7, 0<z1<2, 0<z2≤0.5, 0<z<2, and z=z1+z2; 0<v≤0.3, 0<z1<1.5, 0<z2<0.5, 0.2≤z≤1.8, and z=z1+z2, 0<v≤0.05, 0<z1≤1.5, 0<z2≤0.2, 1.0≤z≤1.8, and z=z1+_{z2}; or 0<v≤0.05, 0<z1<1.5, 0<z2<0.2, 1.0≤z≤1.5, and z=z1+_{z2}. When v, z1, or z2 is not present in the above formulas, v=0, z1=0, or z2=0. For example, when z1=0, z=_{z2}. For example, when _{z2}-0, z=z1.

The compound represented by Formula 4 may, for example, belong to a cubic crystal system and, more specifically, to a F-43m space group. In addition, as described above, the compound represented by Formula 4 may be an argyrodite-type sulfide having an argyrodite-type crystal structure. The compound represented by Formula 4 may include, for example, at least one of monovalent cation elements and divalent cation elements, which are substituted in some of lithium sites in the argyrodite-type crystal structure, may include different types of halogen elements, or may include SOₙ anions substituted in halogen sites, thereby additionally improving lithium ion conductivity and additionally improving electrochemical stability to lithium metals.

The compound represented by Formula 4 may be, for example, Li₆PS₅Cl.

In the present specification, the sulfide solid electrolyte may be an argyrodite-type compound including at least one of Li₇₋ₓPS₆₋ₓClₓ, wherein 0≤x≤2, Li₇₋ₓPS₆₋ₓBrₓ, wherein 0<x≤2, or Li₇₋ₓPS₆₋ₓIₓ, wherein 0<x≤2. In particular, the sulfide solid electrolyte included in the solid electrolyte 30 may be an argyrodite-type compound including at least one of Li₆PS₅Cl, Li₆PS₅Br, or Li₆PS₅I.

The sulfide solid electrolyte may be in the form of powder or molded product. A solid electrolyte in the form of a molded product may be in the form of, for example, a pellet, sheet, or thin film, but one or more embodiments are not necessarily limited thereto. The solid electrolyte may have various forms according to the purpose of use.

A polymer solid electrolyte may include, for example, polyethylene oxide, polypropylene oxide, polystyrene (PS), polyphosphazene, polysiloxane, polyvinylidene fluoride-co-hexafluoropropylene (PVDF-HFP), polyacrylonitrile (PAN), or a combination thereof.

The solid electrolyte 30 may further include, for example, a binder. The binder included in the solid electrolyte 30 may include, for example, SBR, polytetrafluoroethylene, polyvinylidene fluoride, polyethylene, or the like, but one or more embodiments are not limited thereto. Any material may be used as long as the material may be used as a binder in the art. The binder of the solid electrolyte 23 may be the same as or different from binders of the cathode active material layer 12 and an anode active material layer.

In the anode-solid electrolyte sub-assembly 26, the anode current collector 21 may include, for example, a material that does not react with lithium, that is, a material that does not form both an alloy and a compound with lithium. A material constituting the anode current collector 21 may include, for example, copper (Cu), stainless steel, titanium (Ti), iron (Fe), cobalt (Co), and nickel (Ni), but one or more embodiments are not necessarily limited thereto. Any material may be used as long as the material may be used as an electrode current collector in the art. The anode current collector 21 may include one type of the above-described metals or an alloy or coating material of two or more types of metals. The anode current collector 21 may be, for example, in the form of a plate or foil.

Hereinafter, a method of manufacturing a solid secondary battery according to an embodiment will be described below.

First, according to a first manufacturing method, a MIEC structure, the MIEC structure having a plurality of open portions that extend in a direction t and have a structure in which at least one end is open may be prepared.

The plurality of open portions may comprise a plurality of vertical open pores.

A method of preparing the MIEC structure will be described by using, for example, a vertical TiN nanotube. The TiN nanotube may be prepared by using, for example, an anodic oxidation method.

An operating voltage or the like during preparation using the anodic oxidation method may be changed to change a pore size of the TiN nanotube, and a content or the like of distilled water during preparation of an electrolyte used in a preparation process may be changed to change a thickness of the TiN nanotube.

Next, a plurality of lithiophilic metal material particles may be disposed on the MIEC structure. In a process of disposing the plurality of lithiophilic metal material particles, as a non-limiting example, electrodeposition may be used.

During the electrodeposition, a precursor for forming lithiophilic metal material particles and a solvent may be mixed to prepare a composition for forming lithiophilic metal material particles.

As the precursor for forming lithiophilic metal material particles, a lithiophilic metal material-containing salt, which contains Au, Ag, Zn, Mg, Al, Zn, LiF, or a combination thereof, may be used. As the lithiophilic metal material-containing salt, a nitrate, a sulfate, a chloride salt, or a combination thereof, which includes at least one selected from Au, Ag, Zn, Mg, Al, Zn, and LiF, may be used. The lithiophilic metal material-containing salt may include, for example, AgNO₃, HAuCl₄·3H₂O, magnesium nitrate, zinc chloride, zinc nitrate, or zinc sulfate.

Next, an operation of arranging an interlayer on the MIEC structure, on which the plurality of lithiophilic metal material particles are disposed, to prepare a MIEC structure on which the interlayer is disposed may be performed.

When the interlayer is disposed on the MIEC structure, various methods such as slurry coating and transfer methods may be used. When the interlayer is prepared by using the slurry coating method, an interlayer material may be supplied to at least a portion of pores of the MIEC structure to form a first interlayer. In this way, when the first interlayer is formed in the pores, a binding force between the MIEC structure and the interlayer may be greater than when the first interlayer is not formed in the pores.

The first manufacturing method may include stacking the MIEC structure, on which the interlayer is disposed, on an anode current collector and sequentially arranging the anode current collector, the MIEC structure, and the interlayer to prepare an anode; arranging a solid electrolyte on the anode to form an anode-solid electrolyte sub-assembly; and arranging a cathode on another side of the solid electrolyte of the anode-solid electrolyte sub-assembly.

The operation of arranging the interlayer on the MIEC structure on which the plurality of lithiophilic metal material particles are disposed to prepare the MIEC structure on which the interlayer is disposed may be performed through a transfer or coating method.

According to the first manufacturing method, as the solid electrolyte, for example, a sulfide solid electrolyte may be used.

A solid secondary battery according to another embodiment may be manufactured through a second manufacturing method below. In such a manufacturing method, first, a MIEC structure, the MIEC structure having a plurality of open portions that extend in a direction and have a structure of which at least one end is open may be prepared. Next, the solid secondary battery may be manufactured by arranging an interlayer on a solid electrolyte by using an interlayer material to prepare a solid electrolyte/interlayer stack; disposing a plurality of lithiophilic metal material particles on the MIEC structure; disposing the MIEC structure on which lithiophilic metal material particles are disposed on the interlayer of the solid electrolyte/interlayer stack to prepare a solid electrolyte/interlayer/MIEC structure stack; arranging an anode current collector on the MIEC structure of the solid electrolyte/interlayer/MIEC structure stack to form an anode-solid electrolyte sub-assembly; and arranging a cathode on another side of the solid electrolyte of the anode-solid electrolyte sub-assembly. According to such a manufacturing method, the solid electrolyte may be an oxide solid electrolyte, a sulfide solid electrolyte, or the like.

According to the first manufacturing method, a binding force between the MIEC structure and the interlayer may be higher.

A method of manufacturing a solid secondary battery according to an embodiment may include providing a MIEC structure having a plurality of open portions extending in a direction, wherein the plurality of open portions have a structure of which at least one end is open.

The method of manufacturing a solid secondary battery may include arranging an interlayer on the MIEC structure to prepare a MIEC structure on which the interlayer is disposed; stacking the MIEC structure, on which the interlayer is disposed, on an anode current collector, to prepare a stack, wherein the MIEC structure is disposed between the interlayer and the anode current collector; arranging a solid electrolyte on the interlayer of the stack to form an anode-solid electrolyte sub-assembly; and arranging a cathode on another side of the solid electrolyte of the anode-solid electrolyte sub-assembly. The interlayer may include a carbon-containing anode active material, a second metal, a metalloid, or a combination thereof.

The interlayer may be formed, for example, by coating the MIEC with an interlayer-forming composition containing i) a carbon-containing anode active material, and ii) a carbon-containing anode active material, a second metal (M2), a metalloid, or a combination thereof and drying the MIEC.

According to another embodiment, the interlayer may be prepared by coating a first substrate other than the anode current collector with the interlayer-forming composition and drying the first substrate, and arranging a product obtained from such an operation on the anode current collector to separate the first substrate therefrom.

The first substrate may include a material that does not react with lithium, that is, a material that does not form both an alloy and a compound with lithium. A material constituting the first substrate may include, for example, copper (Cu), stainless steel, titanium (Ti), iron (Fe), cobalt (Co), and nickel (Ni), but one or more embodiments are not necessarily limited thereto. Any material may be used as long as the material may be used as an electrode current collector in the art. The first substrate may include one type of the above-described metals or an alloy or coating material of two or more types of metals. The first substrate may be, for example, in the form of a plate or foil. The first substrate may be, for example, a stainless steel substrate.

The method may further include providing a metal thin film between the interlayer and the solid electrolyte.

A thickness of the thin film may be, for example, about 1 nm to about 800 nm, about 10 nm to about 700 nm, about 50 nm to about 600 nm, or about 100 nm to about 500 nm. When the thickness of the thin film is less than 1 nm, it may be difficult for the thin film to function. When the thin film is excessively thick, the thin film itself may adsorb lithium, and thus an amount of lithium precipitated at the anode may decrease, resulting in a decrease in energy density of a solid secondary battery and a decrease in cycle characteristics of the solid secondary battery. The thin film may be disposed on the anode current collector through, for example, vacuum deposition, sputtering, plating, or the like, but one or more embodiments are not necessarily limited to such a method. Any method capable of forming a thin film in the art may be used.

When the solid secondary battery is manufactured, the arranging (for example, bonding) may be performed through a press-compressing process. During a pressing process, some lithium may be injected into the interlayer. Accordingly, the interlayer may include a composite including a carbon-containing active material and lithium or a lithium-second metal (M2) alloy.

According to another embodiment, lithium metal or a lithium metal alloy may be precipitated in vertical open pores during charging, arranging, or both the charging and the arranging of the solid secondary battery.

A pressure applied during pressing or compressing may be, for example, 150 megapascals (MPa) or greater. The pressure applied during the pressing may be, for example, 250 MPa or greater. The pressure applied during the pressing or compressing may be, for example, 1,000 MPa or less, or for example, about 150 MPa to about 10,000 MPa, about 300 MPa to about 5,000 MPa, or about 500 MPa to about 2,000 MPa.

A time for which the pressure is applied may be less than 10 minutes (min). For example, the time for which the pressure is applied may be about 5 milliseconds (ms) to about 10 min. For example, the time for which the pressure is applied may be about 2 min to about 7 min.

The pressing may be performed, for example, at room temperature (25° C.). For example, the pressing may be performed at a temperature of about 15° C. to about 25° C.

However, a pressing temperature is not necessarily limited thereto and may be about 25° C. to about 90° C. or may be a high temperature of 100° C. or greater, for example, about 100° C. to about 500° C.

The pressing may be, for example, roll pressing, uni-axial pressing, flat pressing, warm isotactic pressing (WIP), cold isotactic pressing (ClP), or the like, but one or more embodiments are not necessarily limited to such methods. Any pressing may be used as long as the pressing may be used in the art.

In the charging, the arranging, or both the charging and the arranging of the solid secondary battery, the second metal may form an alloy with lithium in the interlayer.

### Preparation of Cathode

A slurry may be prepared by adding a cathode active material, a binder, and the like, which are materials constituting a cathode active material layer 12, to a non-polar solvent. The prepared slurry may be applied onto a cathode current collector 11 and dried. An obtained stack may be pressed to prepare a cathode 10. The pressing may be, for example, roll pressing, flat pressing, pressing using hydrostatic pressure, or the like, but one or more embodiments are not necessarily limited to such methods. Any pressing may be used as long as the pressing may be used in the art. A pressing process may be omitted. A mixture of materials constituting the cathode active material layer 12 may be compressed into the form of a pellet or stretched (molded) in the form of sheet to prepare the cathode 10. When the cathode 10 is prepared in such a manner, the cathode current collector 11 may be omitted. Alternatively, the cathode 10 may be used by being impregnated with an electrolyte.

### Preparation of Solid Electrolyte

A solid electrolyte 30 including an oxide solid electrolyte may be prepared, for example, by heat-treating a precursor of an oxide solid electrolyte material.

The oxide solid electrolyte may be prepared by bringing precursors into contact with each other in stoichiometric amounts, forming a mixture, and then heat-treating the mixture. The contact may be performed, for example, through milling such as ball milling or pulverizing. The mixture of the precursors mixed in a stoichiometric composition may be primarily heat-treated in an oxidative atmosphere to prepare a primary heat-treatment resultant. The primary heat-treatment may be performed at a temperature of 1,000° C. or less for about 1 hour to about 36 hours. The resultant product of the primary heat-treatment may be pulverized. The pulverizing of the resultant product of the primary heat-treatment may be performed in a wet or dry manner. For example, wet pulverizing may be performed by mixing a solvent such as methanol with the resultant product of the primary heat-treatment, and then milling the resultant mixture for about 0.5 hours to about 10 hours by using a ball mill. Dry pulverizing may be performed by milling the resultant product of the primary heat-treatment by using a ball mill without a solvent. An average particle diameter of the pulverized primary heat-treatment resultant may be about 0.1 μm to about 10 μm or about 0.1 μm to about 5 μm. The pulverized product of primary heat-treatment may be dried. The pulverized product of primary heat-treatment may be mixed with a binder solution and molded in the form of a pellet or may be simply pressed at a pressure of about 1 ton to about 10 tons and molded in the form of a pellet.

A molded product may be subjected to secondary heat-treatment at a temperature less than about 1,000° C. for about 1 hour to about 36 hours. The solid electrolyte 30, which is a sintered product, may be obtained through the secondary heat-treatment. The secondary heat-treatment may be performed at a temperature of, for example, about 550° C. to about 1,000° C. The secondary heat-treatment may be performed for about 1 hour to about 36 hours. In order to obtain the sintered product, a temperature of the secondary heat-treatment may be greater than a temperature of the primary heat-treatment. For example, the temperature of the secondary heat-treatment may be about 10° C. or greater, about 20° C. or greater, about 30° C. or greater, or about 50° C. or greater than the temperature of the primary heat-treatment. The molded product may be subjected to the secondary heat-treatment in an oxidative atmosphere, a reductive atmosphere, or a combination thereof. The secondary heat-treatment may be performed in a) an oxidative atmosphere, b) a reductive atmosphere, or c) an oxidative atmosphere and a reductive atmosphere.

According to another embodiment, there may be provided a solid secondary battery that is a solid secondary battery including a cathode and an anode-solid electrolyte sub-assembly disposed on the cathode, wherein the solid electrolyte is disposed between the cathode and an anode.

The cathode may contain a liquid electrolyte.

### Manufacturing of Solid Secondary Battery

The anode-solid electrolyte assembly 26 and the cathode 10 prepared through such a method may be stacked and then pressed to manufacture a solid secondary battery.

The pressing may be, for example, roll pressing, uni-axial pressing, flat pressing, WIP, ClP, or the like, but one or more embodiments are not necessarily limited to such methods. Any pressing may be used as long as the pressing may be used in the art. A pressure applied during the pressing may be, for example, about 50 MPa to about 750 MPa. A time for which the pressure is applied may be about 5 ms to about 5 min. The pressing may be performed at a temperature, for example, room temperature to about 90° C. or about 20° C. to about 90° C. Alternatively, the pressing may be performed at a high temperature of 100° C. or greater.

Next, the cathode 10 may be disposed on another side of the solid electrolyte 30, to which an anode 20 is bonded, and pressed at a certain pressure to arrange, for example, bond the cathode 10 on another side of the solid electrolyte 30. Alternatively, in the case of the cathode 10 impregnated with a liquid electrolyte, a battery may be manufactured through stacking without pressing.

The pressing may be, for example, roll pressing, uni-axial pressing, flat pressing, WIP, ClP, or the like, but one or more embodiments are not necessarily limited to such methods. Any pressing may be used as long as the pressing may be used in the art. A pressure applied during the pressing may be, for example, about 50 MPa to about 750 MPa. A time for which the pressure is applied may be about 5 ms to about 5 min. The pressing may be performed at a temperature, for example, room temperature to about 90° C. or about 20° C. to about 90° C. Alternatively, the pressing may be performed at a high temperature of 100° C. or greater.

The present inventive concept will be described in more detail through the following Examples and Comparative Examples. However, Examples are for illustrative purposes only, and the scope of the present inventive concept is not limited by Examples.

Preparation of MIEC Structure Coated with a Plurality of Lithiophilic Metal Material Particles

### Preparation Example 1: Preparation of TiN Nanotube (Ag—TiN-3) Coated with Ag Particles

A TiN nanotube was prepared through an anodizing method. Specifically, 0.5 wt % of ammonium fluoride (NH₄F) (Sigma-Aldrich Co. LLC. ≥98%) was added to a solution of ethylene glycol (Sigma-Aldrich Co. LLC. 99.8%, anhydrous) containing 3 vol % of distilled water and then stirred to prepare an electrolyte. Anodizing was performed in the electrolyte at an operating voltage of 60V for 1 hour by using 0.25 mm-thick Ti foil (Thermo Scientific, 99.5%) as a working electrode and using Pt foil as a counter electrode to prepare a primary TiO2 nanotube. Afterwards, primary TiO₂ was removed, and secondary TiO₂ was formed under the same conditions. The secondary TiO₂ (anatase) electrode was heat-treated at a temperature of 800° C. for 1 hour in an NH₃ (99.999%) atmosphere to prepare a TiN nanotube electrode.

The TiN nanotube electrode had an average pore diameter of 100 nm, an average thickness of 40 μm, and an opening structure of which one end is closed.

In order to perform Ag treatment on the TiN nanotube electrode, the TiN nanotube electrode was put into an ethylene glycol-based (EG-based) 0.1 mM AgNO₃ solution, and a current of 0.05 mA/cm² was allowed to flow four times for 1 minute to perform electrochemical deposition. In the TiN nanotube (Ag-TiN-3) coated with Ag particles obtained according to Preparation Example 1, an average particle diameter of the Ag particles was about 20 nm, and a content of the Ag particles was 0.288 parts by weight with respect to 100 parts by weight of the TiN nanotube.

### Preparation Example 2: Preparation of TiN Nanotube (Ag-TiN-1) Coated with Ag Particles

A TiN nanotube (Ag—TiN-1) coated with Ag particles was prepared in the same manner as in Preparation Example 1, except that a Ag treatment process for the TiN nanotube electrode was changed as follows.

The TiN nanotube electrode was put into an EG-based 0.1 mM AgNOs solution, and a current of 0.05 mA/cm² was allowed to flow twice for 1 minute to perform electrochemical deposition.

In the TiN nanotube (Ag—TiN-1) coated with Ag particles obtained according to Preparation Example 2, an average particle diameter of the Ag particles was about 50 nm, and a content of the Ag particles was 0.144 parts by weight with respect to 100 parts by weight of the TiN nanotube.

### Preparation Example 3: Preparation of TiN Nanotube (Ag—TiN-2) Coated with Ag Particles

A TiN nanotube (Ag—TiN-2) coated with Ag particles was prepared in the same manner as in Preparation Example 1, except that a Ag treatment process for the TiN nanotube electrode was changed as follows.

The TiN nanotube electrode was put into an EG-based 0.1 mM AgNO₃ solution, and a current of 0.05 mA/cm² was allowed to flow four times for 30 seconds to perform electrochemical deposition.

In the TiN nanotube (Ag—TiN-2) coated with Ag particles obtained according to Preparation Example 3, an average particle diameter of the Ag particles was about 35 nm, and a content of the Ag particles was 0.144 parts by weight with respect to 100 parts by weight of the TiN nanotube.

According to Preparation Examples 1 to 3, the Li nucleation overpotential of Ag-TiN nay be adjusted according to Ag coating conditions.

### Preparation Example 4: Preparation of TiN Nanotube (Au—TiN-2) Coated with Au Particles

A TiN nanotube electrode was put into a 1 mM HAuCl₄·3H₂O solution, and a current of 1 mA/cm² was allowed to flow once for 1 minute to perform electrochemical deposition and prepare a TiN nanotube (Au—TiN) coated with Au particles.

In the TiN nanotube (Au—TiN-2) coated with Ag particles obtained according to Preparation Example 4, an average particle diameter of the Au particles was about 10 nm, and a content of the Au particles was 0.875 parts by weight with respect to 100 parts by weight of the TiN nanotube.

### Comparative Preparation Example 1: Preparation of TiN Nanotube Coated with ZnO Film

ZnO particle treatment was performed on a surface of a TiN nanotube electrode according to atomic layer deposition (ALD) to prepare a TiN nanotube coated with a ZnO film. Diethylzinc (DEG) and H₂O were used as a Zn precursor and an O precursor, respectively. As deposition conditions, a chamber temperature was controlled to be 150° C., a line temperature was controlled to be 100° C., and deposition was performed at a temperature of 80° C.

A deposition process was performed in order of pulse (time T1 for which each source was opened and closed), exposure (time T2 for which each source was left in a vacuum or without Ar gas), Ar gas purging (time T3 for which non-reacting sources were discharged). Cycles were performed under conditions in Table 1 by using a Zn source and a H₂O source in the stated order, and each cycle was performed repeatedly to perform 200 cycles.

TABLE 1

| | | | Argon gas |
|---|---|---|---|
| | Pulse T1 | Exposure T2 | purging T3 |
| Classification | (seconds) | (seconds) | (seconds) |
| Zn source | 0.1 | 20 | 20 |
| H₂O source | 0.05 | 20 | 20 |

### Preparation Example 5

A TiN nanotube electrode was prepared in the same manner as in Preparation Example 1, except that an operating voltage was changed to adjust an average diameter of pores and a thickness of a MIEC structure as shown in Table 2 below and a content of distilled water was changed to 2 vol % during preparation of an electrolyte.

### Preparation Example 6

A TiN nanotube electrode was prepared in the same manner as in Preparation Example 1, except that an operating voltage was changed to adjust an average diameter of pores and a thickness of a MIEC structure as shown in Table 2 below and a content of distilled water was changed to 2.5 vol % during preparation of an electrolyte.

### Preparation Example 7

A TiN nanotube electrode was prepared in the same manner as in Preparation Example 1, except that an operating voltage was changed to about 40 V to adjust an average diameter of pores and a thickness of a MIEC structure as shown in Table 2 below.

### Preparation Example 8

A TiN nanotube electrode was prepared in the same manner as in Preparation Example 1, except that an operating voltage was changed to about 50 V to adjust an average diameter of pores and a thickness of a MIEC structure as shown in Table 2 below.

TABLE 2

| | | | | Average | Content |
|---|---|---|---|---|---|
| | | | | particle | (parts by |
| | | | | diameter | weight) |
| | | | | (nm) of | of metal |
| | Average | | Average | metal | material |
| | diameter | | diameter | particles | particles |
| | (nm) of | Thickness | (nm) of | applied | applied |
| | pores of | (μm) of | pores of | onto | onto |
| Classifi- | MIEC | MIEC | interlayer | MIEC | MIEC |
| cation | structure | structure | (Ag/C) | structure | structure |
| Preparation | 100 | 40 | 50 | 20 | 0.288 |
| Example 1 | | | | | |
| (Ag—TiN-3) | | | | | |
| Preparation | 100 | 40 | 50 | 50 | 0.144 |
| Example 2 | | | | | |
| (Ag—TiN-1) | | | | | |
| Preparation | 100 | 40 | 50 | 35 | 0.144 |
| Example 3 | | | | | |
| (Ag—TiN-2) | | | | | |
| Preparation | 100 | 40 | 50 | 35 | 0.144 |
| Example 4 | | | | | |
| (Au—TiN-2) | | | | | |
| Preparation | 120 | 15 | 50 | 20 | 0.288 |
| Example 5 | | | | | |
| (Ag—TiN-3) | | | | | |
| Preparation | 120 | 25 | 50 | 20 | 0.288 |
| Example 6 | | | | | |
| (Ag—TiN-3) | | | | | |
| Preparation | 65 | 5 | 50 | 20 | 0.288 |
| Example 7 | | | | | |
| (Ag—TiN-3) | | | | | |
| Preparation | 90 | 10 | 50 | 20 | 0.288 |
| Example 8 | | | | | |
| (Ag—TiN-3) | | | | | |

The average diameter of pores and the thickness in Table 2 were confirmed through SEM analysis.

Referring to Table 2, a pore volume is proportional to a pore diameter and a length of the MIEC structure. Since lithium from a cathode is precipitated in a space inside the MIEC structure, when a capacity of the cathode increases, the pore diameter or length in the MIEC structure may be adjusted to provide a space for storing the precipitated lithium.

### Manufacturing of Solid Secondary Battery

### Example 1: Use of Sulfide Solid Electrolyte

### Preparation of Anode-Solid Electrolyte Sub-Assembly

A 600 μm-thick pellet including a Li₆PS₅Cl sulfide solid electrolyte was used as a solid electrolyte.

CB (3 g) with a particle diameter of about 38 nm as a carbon-containing material and 1 g of silver (Ag) particles with an average particle diameter of about 100 nm were mixed, and a mixture, which was obtained by mixing 2.692 g of a polyvinyl alcohol-polyacrylic acid (PVA-PAA) binder solution (Solef® 5130 manufactured by Solvay Specialty Polymers) with 7 g of N-methyl-2-pyrrolidone (NNP), was added thereto, and primarily stirred at a speed of 1,000 revolutions per minute (rpm) for 30 min to prepare a slurry. The slurry was cast on the TiN nanotube coated with Ag particles prepared according to Preparation Example 1, dried at room temperature (25° C.) for 1 hour, and then vacuum-dried at a temperature of 120° C. for 2 hours to prepare an interlayer with a thickness of about 10 μm, thereby preparing a MIEC structure/interlayer stack.

The MIEC structure/interlayer stack was stacked on 10 μm-thick copper (Cu) foil, which was an anode current collector, to form an anode. A solid electrolyte was disposed on the interlayer of the anode to form an anode-solid electrolyte sub-assembly. A volume of pores in the anode-solid electrolyte sub-assembly was controlled to correspond to a capacity of a cathode.

### Preparation of Cathode

LiNi_{0.7}Co_{0.15}Al_{0.15}O₂ (NCA) (D50=12 μm) as a cathode active material, carbon nanofibers as a conductive material, and Li₆PS₅Cl (D50−5 μm) as a solid electrolyte were mixed, and then xylene was added thereto to prepare a cathode slurry. The prepared cathode slurry was molded in the form of a sheet to prepare a cathode sheet. A mixing weight ratio of cathode active material:conductive material:sulfide solid electrolyte was 85:2:15. The cathode sheet (with a thickness of about 130 μm) was used as a cathode. A capacity of the cathode was about 4.3 mAh/cm².

### Manufacturing of Solid Secondary Battery

The solid electrolyte of the anode-solid electrolyte sub-assembly was disposed on the cathode and pressed at a temperature of 25° C. and a pressure of 300 MPa by using WIP to manufacture a solid secondary battery having a disk shape with a diameter of 13 mm.

### EXAMPLES 2 TO 8

Solid secondary batteries were manufactured in the same manner as in Example 1, except that, when an anode-solid electrolyte sub-assembly was prepared, the TiN nanotubes prepared in Preparation Examples 2 to 8 were used as MIECs.

### EXAMPLE 9

A solid secondary battery was manufactured in the same manner as Example 1, except that, when an interlayer was prepared, instead of 3 g of CB with a particle diameter of about 38 nm as a carbon-containing material and 1 g of silver (Ag) particles with an average particle diameter of about 100 nm, 4 g of CB with a particle diameter of about 38 nm as a carbon-containing material was used.

### Comparative Example 1: Solid Secondary Battery (Use of Sulfide Solid Electrolyte:No MIEC Structure)

### Preparation of Anode-Solid Electrolyte Sub-Assembly

A 600 μm-thick pellet including a Li₆PS₅Cl sulfide solid electrolyte was used as a solid electrolyte.

CB (3 g) with a particle diameter of about 38 nm as a carbon-containing material and 1 g of silver (Ag) particles with an average particle diameter of about 100 nm were mixed, and a mixture, which was obtained by mixing 2.692 g of a PVA-PAA binder solution (Solef® 5130 manufactured by Solvay Specialty Polymers) with 7 g of NNP, was added thereto, and primarily stirred at a speed of 1,000 rpm for 30 min to prepare a slurry. The slurry was applied on a stainless steel substrate through bar coating, dried at room temperature (25° C.) for 1 hour, and then vacuum-dried for 12 hours to prepare an interlayer.

The interlayer was stacked on a 10-μm-thick copper (Cu) foil, which was an anode current collector, and then the stainless steel substrate was removed from the interlayer to dispose the interlayer on the anode current collector.

The anode current collector on which the interlayer was formed was disposed on the solid electrolyte.

Thus, a solid secondary battery of Comparative Example 1 was manufactured in the same manner as the solid secondary battery of Example 1 without the MIEC structure.

When the solid secondary battery manufactured according to Comparative Example 1 was charged, a lithium metal precipitation layer was formed between the interlayer and the anode current collector.

### Comparative Example 2: Solid Secondary Battery (TiN+AgC Coated with ZnO Film)

A solid secondary battery was manufactured in the same manner as in Example 1, except that, instead of the TiN nanotube coated with Ag particles of Preparation Example 1, which was a MIEC structure, the TiN nanotube coated with a ZnO film prepared according to Comparative Preparation Example 1 was used.

### Comparative Example 3: Solid Secondary Battery (No AgC Layer being Interlayer)

A solid secondary battery was manufactured in the same manner as in Example 1, except that an interlayer was not stacked on a MIEC structure.

### Comparative Example 4: Solid Secondary Battery (AgC Layer being Formed Between MIEC Structure and Anode Current Collector)

A solid secondary battery was manufactured according to Comparative Example 1, except that an anode-solid electrolyte subassembly was prepared according to the following process wherein the interlayer was disposed between the MIEC structure and anode current collector and not between the MIEC structure and the solid electrolyte.

### Evaluation Example 1: SEM-EDX Analysis

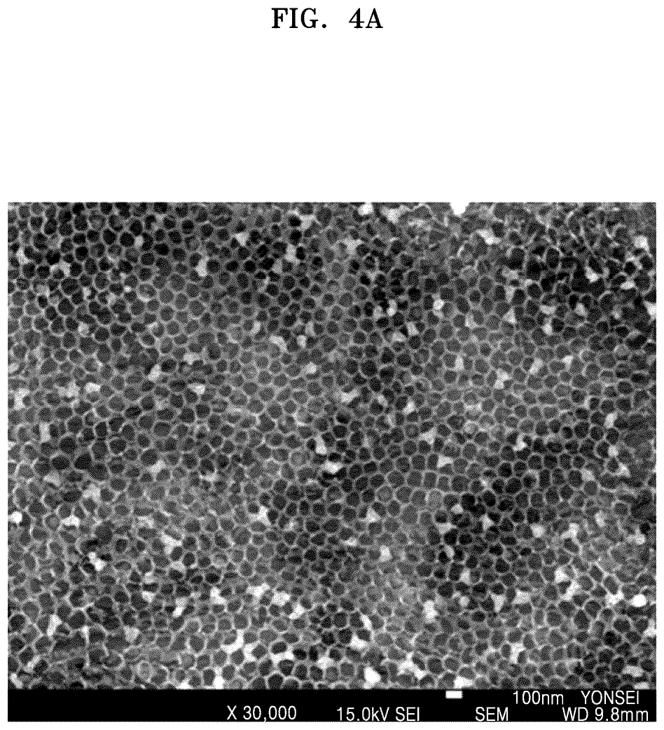

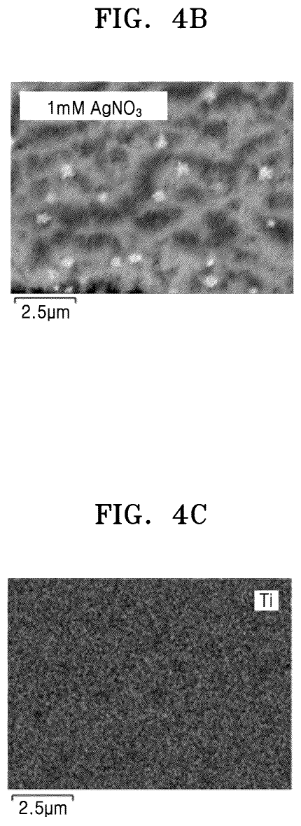

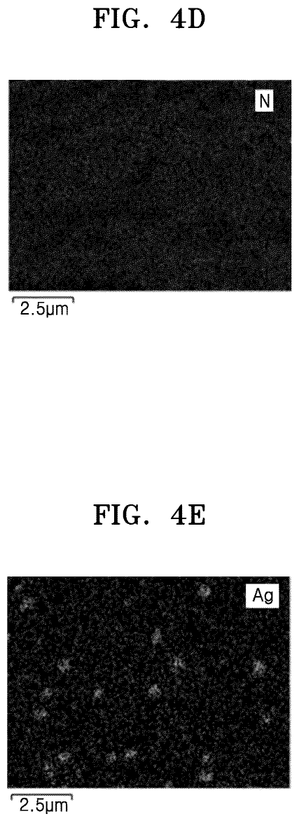

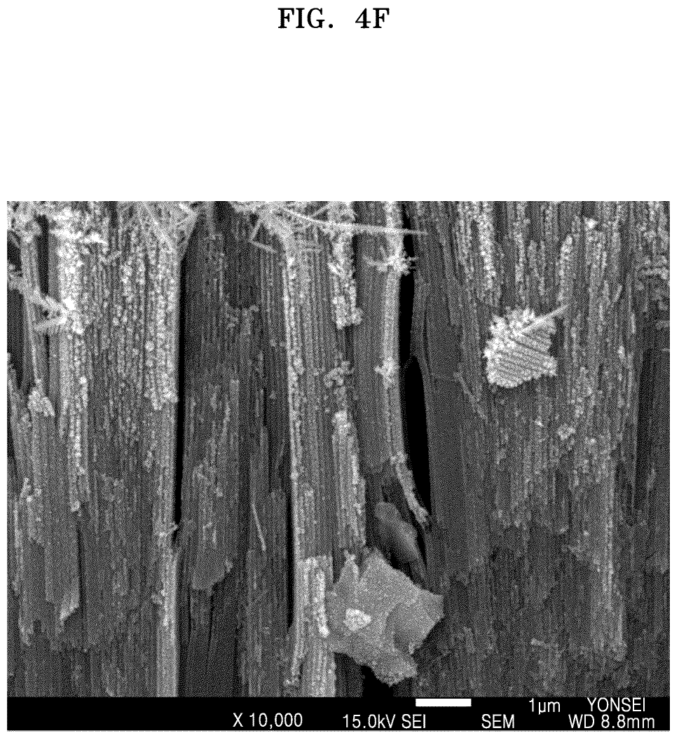

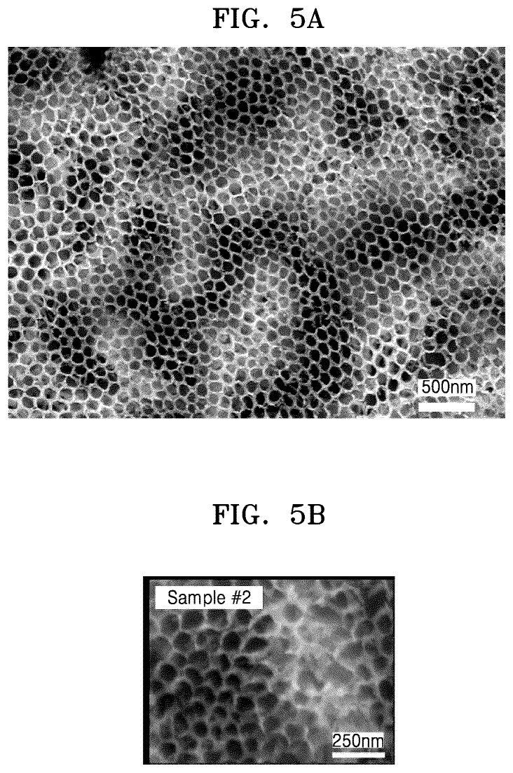

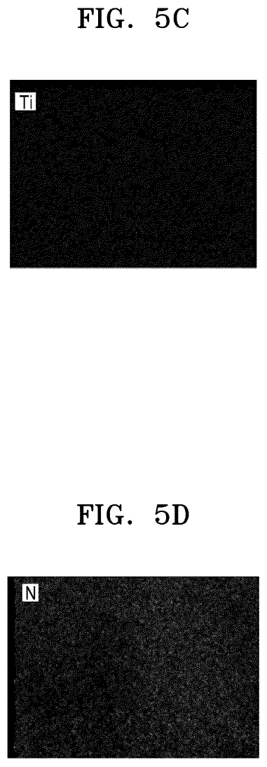

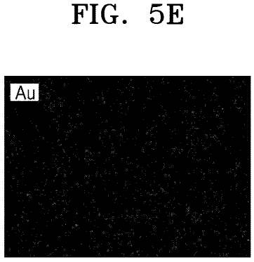

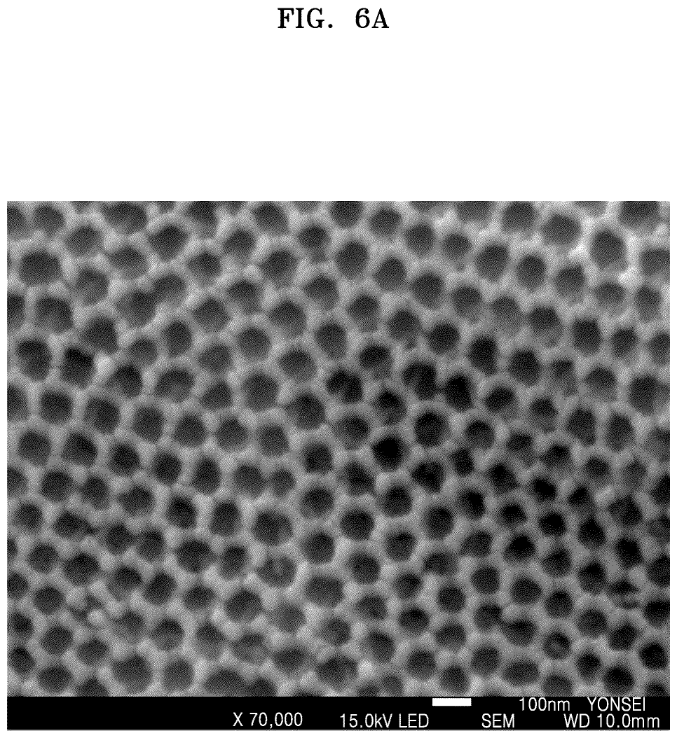

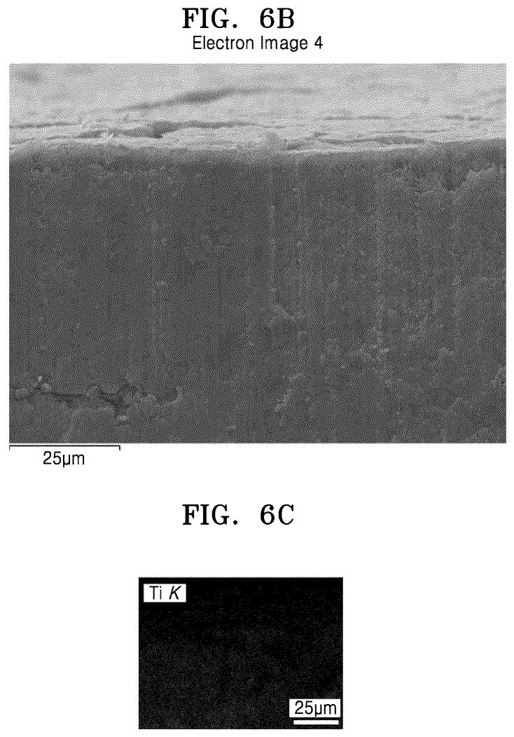

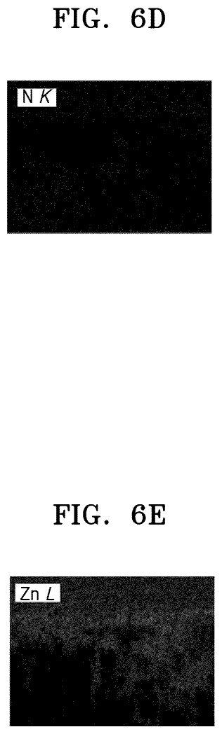

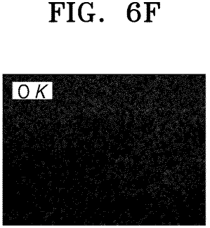

Scanning electron microscopy-energy dispersive X ray diffraction (SEM/EDX) analysis was performed on the TiN nanotubes according to Preparation Example 1, Preparation Example 4, and Comparative Preparation Example 1. Analysis results thereof are shown in FIGS. 4A to 4F, 5A to 5E, and 6A to 6F. FIGS. 4A to 4F show the TiN nanotube onto which silver particles are applied in an agglomerate form according to Preparation Example 1, FIGS. 5A to 5E show the TiN nanotube onto which gold particles are applied in an island form according to Preparation Example 4, and FIGS. 6A to 6F show the TiN nanotube on which a ZnO film is continuously applied according to Comparative Preparation Example 1.

It could be seen that, as shown in FIGS. 4A and 5A, the TiN nanotubes prepared according to Preparation Example 1 and Preparation Example 4 each had a structure having an average pore diameter of about 100 nm and an average thickness of about 40 μm. It could be seen that the silver particles were present on the TiN nanotube of Preparation Example 1 as shown in FIGS. 4B and 4E, and the gold particles were present on the TiN nanotube of Preparation Example 4 as shown in FIGS. 5B and 5E.

As shown in FIG. 6A, the TiN nanotube prepared according to Comparative Preparation Example 1 had a structure having an average pore diameter of about 100 nm and an average thickness of about 40 μm like the TiN nanotubes prepared according to Preparation Example 1 and Preparation Example 4. It could be confirmed that, as shown in a SEM image of FIG. 6B, the TiN nanotube of Comparative Preparation Example 1 had a structure in which a ZnO-containing coating film was continuously formed on the TiN nanotube. As shown in FIGS. 6E and 6F, a composition in which ZnO was present on the TiN nanotube could be confirmed.

### Evaluation Example 2: Change in Pressure According to Charging or Discharging

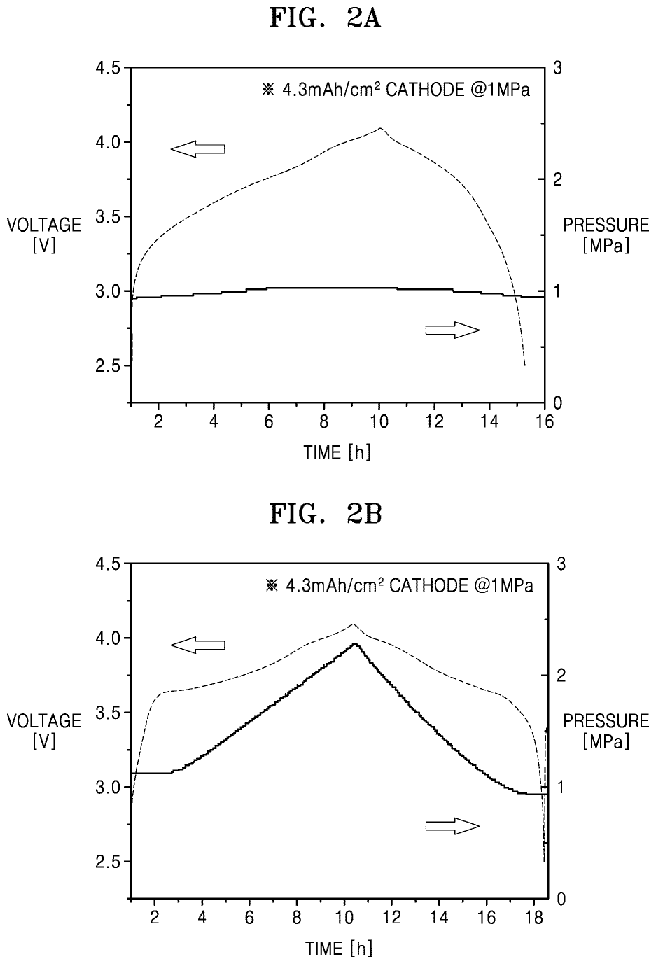

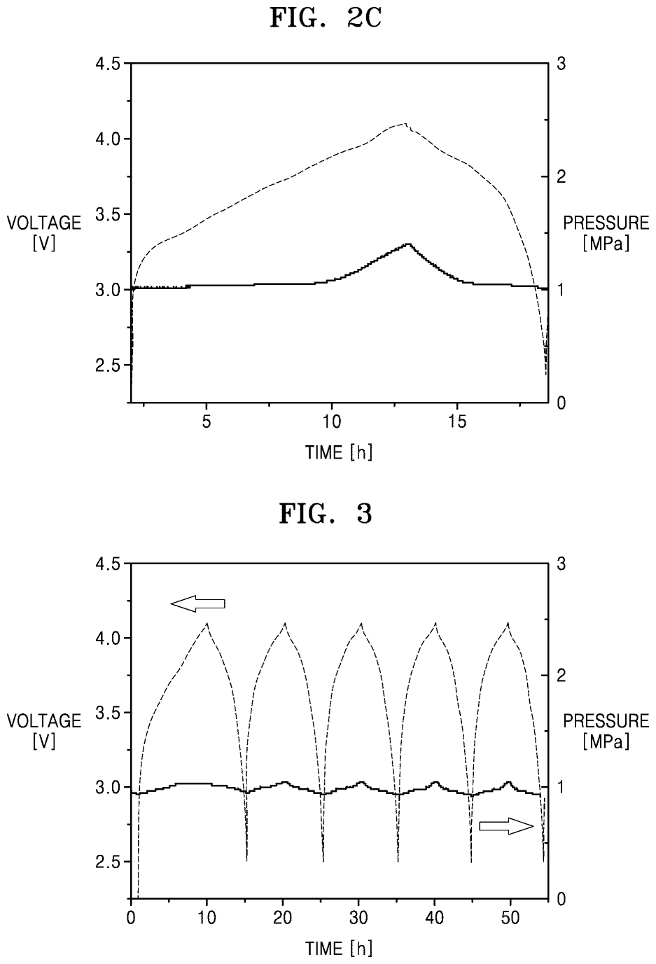

The solid secondary batteries of Example 1, Comparative Example 1, and Comparative Example 2 were charged up to an end-of-charge voltage of 4.1 V at a charge current of 0.1 coulombs (C) at a temperature of 25° C. and discharged at a discharge current of 0.1 C under a condition of a cutoff voltage of 2.5 V. Then, a change in pressure was assessed. Graphs illustrating the charge/discharge characteristics over time are shown in FIGS. 2A to 2C. Here, an operating pressure was about 1 MPa. FIG. 2A shows the charge/discharge characteristics and change in pressure of the solid secondary battery of Example 1. FIGS. 2B and 2C show the charge/discharge characteristics and pressure profiles of the solid secondary batteries of Comparative Example 1 and Comparative Example 2, respectively.

As shown in FIG. 2B, in the solid secondary battery of Comparative Example 1, a pressure was changed by 1.1 MPa or greater due to cell volume expansion caused by lithium precipitation. During discharging, external pressure was required to push lithium, and deterioration occurred due to internal strain of a cell. As a result, it could be seen that an amount of change in internal stress in the solid secondary battery of Comparative Example 1 was increased in comparison to the solid secondary battery of Example 1.

For the solid secondary battery of Comparative Example 2, as shown in FIG. 2C, when a lithiophilic ZnO film was applied onto the TiN structure through ALD, a change in internal stress in a battery was 0.4 MPa.

On the other hand, in the solid secondary battery of Example 1, as shown in FIG. 2A, there was almost no change in pressure at the same charge amount so that a change in internal stress was less than 0.1 MPa. In this way, lithium was precipitated inside the MIEC structure during charging or discharging, and thus changes in thickness and internal stress were considerably reduced, which made it possible to drive an anode without the occurrence of strain. As a result, a change in internal stress could be minimized, thereby improving cell lifespan characteristics and securing low-pressure driving characteristics.

As described above, as a result of measuring the change in internal pressure during charging or discharging of the solid secondary battery according to Example 1, while an amount of change in pressure of the solid secondary battery of Comparative Example 1, which was not subjected to Li affinity treatment, was about 1.1 MPa, and an amount of change in pressure of the solid secondary battery of Comparative Example 2 was about 0.4 MPa, an amount of change in pressure of the solid secondary battery of Example 1 was less than about 0.1 MPa, which showed a pressure reduction effect. The reason for such results was because Li passing through the interlayer (AgC layer) was smoothly moved to the MIEC structure (Ag—TiN) coated with silver particles, which had a greater affinity for Li than the interlayer (AgC layer), and was precipitated inside the TiN nanotube. On the other hand, when the affinity for Li of the interlayer (AgC layer) was greater than that of the TiN nanotube, some Li remained in the interlayer (AgC layer) to be precipitated inside the interlayer (AgC layer) or at an interface between the interlayer (AgC layer) and the MIEC structure (TiN nanotube). Thus, a pressure of the solid secondary battery was increased.

### Evaluation Example 3: Charge/Discharge Characteristics I

The solid secondary batteries of Example 1, Comparative Example 1, Comparative Example 3, and Comparative Example 4 were evaluated according to the following method to investigate charge/discharge profile characteristics.

The solid secondary batteries were charged at a constant current rate of 0.1 C until a voltage reached 4.1 V (vs. Li), and then, in constant voltage mode, while 4.1 V was maintained, the charging was cut-off at a current rate of 0.05 C. Subsequently, the solid secondary batteries were discharged at a constant current rate of 0.1 C until the voltage reached 2.5 V (vs. Li) during discharging (formation operation).

The solid secondary batteries subjected to a formation cycle were charged at a constant current rate of 0.1 C at a temperature of 25° C. until the voltage reached 4.1 V (vs. Li). Subsequently, the sloid secondary batteries were discharged at a constant current rate of 0.1 C until the voltage reached 2.5 V (vs. Li) during discharging. A C rate is a discharge rate of a cell and is a value obtained by dividing the total capacity of the cell by a total discharge time of 1 hour. For example, the C rate of a battery with a discharge capacity of 1.6 amperes-amperes is 1.6 amperes. The total capacity is determined according to a discharge capacity of a 1^{st} cycle. 0.1C or C/10 refers to a current at which a battery is fully discharged in 10 hours.

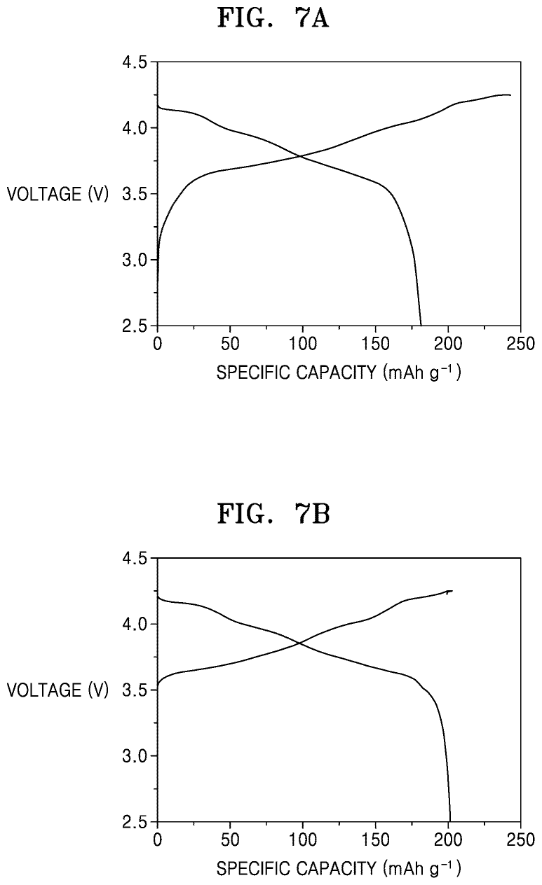

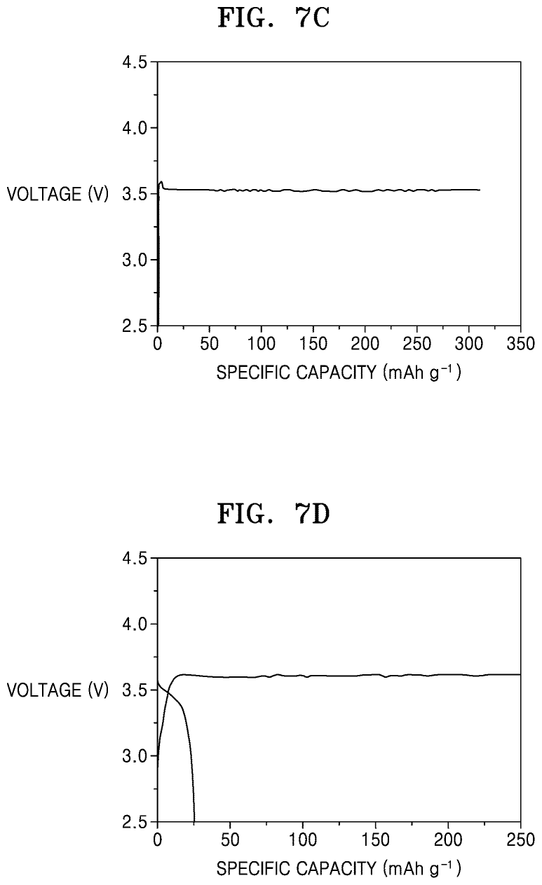

Changes in voltage according to a specific capacity after a charging or discharging process of the solid secondary batteries of Example 1, Comparative Example 1, Comparative Example 3, and Comparative Example 4 were evaluated and data is shown in FIGS. 7A to 7D, respectively.

The solid secondary battery of Comparative Example 1 showed an initial charge profile in which a short circuit occurred as shown in FIG. 7B.

As shown in FIG. 7C, in the solid secondary battery of Comparative Example 3, which used only the TiN MIEC structure alone without the AgC layer which was an interlayer, during charging, a micro-short circuit, by which a voltage could not rise, occurred, which made it difficult to normally operate a cell. Such a result is likely attributable to, in the case of the TiN nanotube alone, concentration of the current on a contact interface between the electrolyte and the TiN nanotube, while Li dendrites are formed, and thus, a short circuit occurs.

The solid secondary battery of Comparative Example 4 had a structure in which the AgC layer was directly stacked on the anode current collector, and in this case, it was observed that a micro-short circuit occurred during charging as shown in FIG. 7D.

On the other hand, the solid secondary battery of Example 1 was charged or discharged as shown in FIG. 7A. When the AgC layer was formed on the TiN nanotube, a current was dispersed to suppress a phenomenon in which Li grown at a tip, charging or discharging was performed. Therefore, it can be seen that an AgC layer between an electrolyte and a MIEC structure provides a strain-free anode in which Li is precipitated in a TiN tube structure. Since silver particles were applied onto the TiN nanotube, a lithium nucleation overpotential was less than that of the AgC layer, and thus lithium was smoothly moved into the MIEC structure, resulting in excellent charge/discharge characteristics.

In addition, the charge/discharge characteristics of the solid secondary batteries of Examples 2 to 9 were evaluated in the same manner as the charge/discharge characteristics of the solid secondary battery of Example 1 described above.

The solid secondary batteries of Examples 2 to 9 were charged or discharged normally.

### Evaluation Example 4: Pressure Change Profile According to Charging or Discharging

A change in pressure due to repeated charging or discharging of the solid secondary battery according to Example 1 was evaluated according to the following method.

The solid secondary battery was charged at a constant current rate of 0.1 C until a voltage reached 4.1 V (vs. Li), and then, in constant voltage mode, while 4.1 V was maintained, the charging was cut-off at a current rate of 0.05 C. Subsequently, the solid secondary battery was discharged at a constant current rate of 0.1 C until the voltage reached 2.5 V (vs. Li) during discharging (formation operation).

The solid secondary battery subjected to a formation cycle was charged at a constant current rate of 0.1 C at a temperature of 25° C. until the voltage reached 4.1 V (vs. Li). Subsequently, the solid secondary battery was discharged at a constant current rate of 0.1 C until the voltage reached 2.5 V (vs. Li) during discharging (1^{st} cycle).

Such a charge/discharge cycle was repeated 5 times.

Afterwards, a change in pressure according to charging or discharging was assessed and the results are shown in FIG. 3.

The change in internal pressure after 1 cycle was 0.08 MPa, and a change in internal pressure after 2 cycles was 0.1 MPa, which showed a pressure reduction effect in which an amount of change in internal pressure was less than 0.1 MPa. As shown in FIG. 3, the solid secondary battery of Example 1 showed a very small increase in internal pressure according to a repeated charge/discharge cycle, and thus an internal pressure of a cell was maintained at an almost constant level. Such a result was attributed to the lithiophilic treatment on the TiN nanotube, as lithium fills the inside of the TiN nanotube to maintain a strain-free effect. Li passing through the interlayer (AgC layer) can move smoothly to the MIEC structure (Ag—TiN) coated with silver particles, which has a higher affinity for Li than the interlayer (AgC layer), and can precipitate inside the TiN nanotube. On the other hand, when the affinity for Li of the interlayer (AgC layer) is greater than that of the TiN nanotube, some Li remains in the interlayer (AgC layer) to be precipitated inside the interlayer (AgC layer) or at an interface between the interlayer (AgC layer) and the MIEC structure (TiN nanotube). Thus, increasing internal pressure., when an anode is provided as multiple layers, a solid secondary battery with excellent cell performance may be manufactured by using a 3D MIEC with high Li affinity where Li can be readily precipitated inside the MIEC structure.

### Evaluation Example 5: Initial Efficiency

The initial efficiency of the solid secondary batteries manufactured according to Example 1 and Comparative Example 2 were evaluated under the following conditions.

The solid secondary batteries were charged at a constant current rate of 0.1 C until a voltage reached 4.1 V (vs. Li), and then, in constant voltage mode, while 4.1 V was maintained, the charging was cut-off at a current rate of 0.05 C. Subsequently, the solid secondary batteries were discharged at a constant current rate of 0.1 C until the voltage reached 2.5 V (vs. Li) during discharging (formation operation).

The solid secondary batteries subjected to a formation cycle were charged at a constant current rate of 0.1 C at a temperature of 25° C. until the voltage reached 4.1 V (vs. Li). Subsequently, the sloid secondary batteries were discharged at a constant current rate of 0.1 C until the voltage reached 2.5 V (vs. Li) during discharging.

Initial charge/discharge efficiency after a 1^{st} cycle was evaluated and results are shown in Table 3.

$$initial charge / discharge efficiency ( \% ) = ( {1}^{st} cycle discharge capacity / {1}^{st} cycle charge capacity ) \times 100 \qquad Equation 1$$

TABLE 3

| Classification | Initial efficiency (%) |
|---|---|
| Example 1 | 55.6 |
| Comparative Example 2 | 49.2 |

As shown in Table 3, the initial charge/discharge efficiency of the solid secondary battery of Example 1, which had the MIEC structure onto which Ag particles were applied in an agglomerate form, was greater than the solid secondary battery of Comparative Example 2 which had the MIEC structure in which a ZnO-containing coating film was continuously formed on the TiN nanotube.

### Evaluation Example 6: Lithium Nucleation Overpotential

A lithium nucleation overpotential according to current density was assessed for the solid secondary batteries of Example 1 and Comparative Example 1.

Each solid secondary battery was charged or discharged under the following conditions, and an overpotential during a precipitation (electrodeposition) and dissolution process of lithium was measured.

After an evaluation electrode and a solid electrolyte were put into a torque cell and the torque cell was pressed at a pressure 250 MPa for 90 seconds, lithium metal foil was added to additionally press the torque cell at a pressure of 50 MPa for 90 seconds, and then a cell was manufactured and evaluated while pressed at a pressure of 5 MPa. Lithium metal is electrodeposited on an anode up to a certain capacity (0.5 mAh/cm²) at a constant current and then dissolved up to 1V. In a 1^{st} cycle, the anode was activated at a current of 0.05 mA/cm², and then the current was increased in order of 0.1 mA/cm², 0.3 mA/cm², and 0.5 mA/cm².

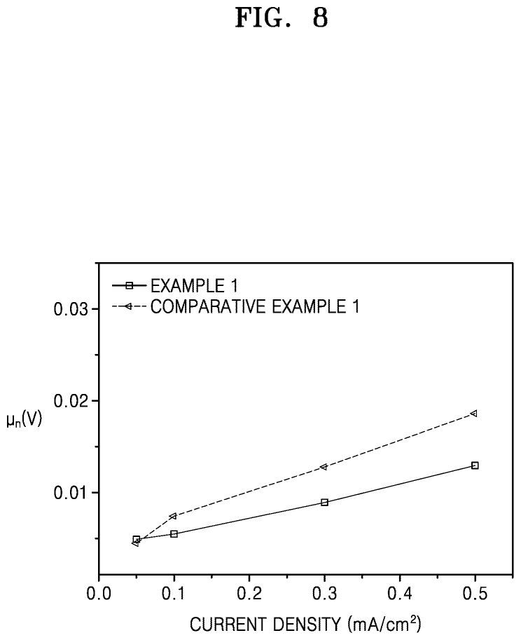

Results of evaluating the lithium nucleation overpotential in the solid secondary batteries of Example 1 and Comparative Example 1 subjected to the above-described charging or discharging are shown in FIG. 8.

Referring to FIG. 8, it can be seen that the lithium nucleation overpotential of the solid secondary battery of Example 1 was less than the solid secondary battery of Comparative Example 1. From the results, it can be seen that the MIEC structure coated with lithiophilic metal material particles in the anode of the solid secondary battery of Example 1 can contribute to the transfer and growth of lithium ions during a charging process.

While one or more embodiments have been described with reference to the drawings and Examples, the description merely illustrates, and it will be understood by those of ordinary skill in the art that various modifications and other equivalent embodiments are possible therefrom. Therefore, the protection scope of the present application should be defined by the appended claims.

When an anode-solid electrolyte sub-assembly for a solid secondary battery according to an embodiment is used, a change in thickness due to electrodeposition/desorption of lithium metal in an anode during charging or discharging may be reduced, thereby manufacturing a solid secondary battery having improved high-rate characteristics, energy density, and lifespan characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An anode-solid electrolyte sub-assembly for a solid secondary battery, the anode-solid electrolyte sub-assembly comprising:
an anode current collector;
a mixed ionic-electronic conductor structure disposed between the anode current collector and a solid electrolyte, the mixed ionic-electronic conductor structure having a plurality of open portions that extend in a direction from the anode current collector towards the solid electrolyte, wherein at least one end of an open portion of the plurality of open portions is open;
a plurality of lithiophilic metal material particles disposed on a surface of the mixed ionic-electronic conductor structure;
an interlayer disposed between the mixed ionic-electronic conductor structure on which the plurality of lithiophilic metal material particles are disposed and the solid electrolyte; and
wherein the interlayer comprises an interlayer material comprising
a carbon-containing anode compound;
lithium;
a mixture of the carbon-containing anode compound and at least one of a second metal or a metalloid, a composite of the carbon-containing anode compound and at least one of a second metal or a metalloid, or a combination thereof.

2. The anode-solid electrolyte sub-assembly of claim 1, wherein the plurality of lithiophilic metal material particles are disposed in an agglomerate form and comprise Au, Ag, Zn, Mg, Al, Zn, LiF, or a combination thereof.

3. The anode-solid electrolyte sub-assembly of claim 1, wherein the lithiophilic metal material particles disposed on the mixed ionic-electronic conductor structure are disposed on an inner surface of the open portions and on an end surface of the mixed ionic-electronic conductor structure.

4. The anode-solid electrolyte sub-assembly of claim 1, wherein an average particle size of the plurality of lithiophilic metal material particles is less than or equal to an average diameter of the open portions of the mixed ionic-electronic conductor structure.

5. The anode-solid electrolyte sub-assembly of claim 1, wherein an average particle size of the lithiophilic metal material particles is about 10 nanometers to about 60 nanometers.

6. The anode-solid electrolyte sub-assembly of claim 1, wherein a content of the lithiophilic metal material particles is about 0.01 part by weight to about 5 parts by weight, with respect to 100 parts by weight of the mixed ionic-electronic conductor structure.

7. The anode-solid electrolyte sub-assembly of claim 1, wherein a coverage ratio of an area occupied by the lithiophilic metal material particles to an area of the mixed ionic-electronic conductor structure is 0.30 or greater.

8. The anode-solid electrolyte sub-assembly of claim 1, wherein the plurality of open portions comprising the structure wherein at least one end of an open portion of the plurality of open portions is open comprises a plurality of open pores.

9. The anode-solid electrolyte sub-assembly of claim 1, wherein each open portion of the plurality of open portions comprising the structure wherein at least one end is open and has a tube shape extending in the direction from the anode current collector towards the solid electrolyte.

10. The anode-solid electrolyte sub-assembly of claim 1, wherein at least a portion of the plurality of open portions comprises an interlayer material.

11. The anode-solid electrolyte sub-assembly of claim 8, wherein a porosity of the mixed ionic-electronic conductor structure is 60% or greater,
an average pore diameter of the mixed ionic-electronic conductor structure is about 5 nanometers to about 200 nanometers, and
a thickness of the mixed ionic-electronic conductor structure is about 1 micrometers to about 100 micrometers.

12. The anode-solid electrolyte sub-assembly of claim 1, wherein the mixed ionic-electronic conductor structure comprises a carbon-containing material, silicon, aluminum, titanium nitride, titanium carbide, tantalum nitride, tungsten nitride, iron nitride, nickel, or niobium oxynitride; a lithiated compound of at least one of a carbon-containing material, silicon, aluminum, titanium nitride, titanium carbide, tantalum nitride, tungsten nitride, iron nitride, nickel, niobium oxynitride; or a combination thereof.

13. The anode-solid electrolyte sub-assembly of claim 1, wherein the mixed ionic-electronic conductor comprises a material including titanium nitride, titanium carbide, Ta₃N₅, FeₓN wherein 2≤x≤4, W₂N, NbaOₓN_{y} wherein 0≤a≤2, 0≤x≤2, and 0≤y≤2, or a combination thereof; a lithiated compound of the material; a mixture of the material and a carbon-containing material; a composite of the material and a carbon-containing material; or a combination thereof.

14. The anode-solid electrolyte sub-assembly of claim 1, wherein the carbon-containing anode active material comprises amorphous carbon, wherein the amorphous carbon comprises carbon black, acetylene black, furnace black, KETJEN black, graphene, carbon nanotubes, carbon nanofibers, or a combination thereof, and
at least one of the second metal and the metalloid comprises of tin, indium, silicon, gallium, aluminum, titanium, zirconium, niobium, germanium, antimony, bismuth, zinc, gold, platinum, palladium, nickel, iron, cobalt, chromium, magnesium, cesium, cerium, molybdenum, silver, sodium, potassium, calcium, yttrium, tantalum, hafnium, barium, vanadium, strontium, tellium, or lanthanum.

15. The anode-solid electrolyte sub-assembly of claim 8, wherein the plurality of open pores comprises a first metal material,
wherein the first metal material comprises lithium, an alloy of lithium and the first metal, or a combination thereof, and
the first metal comprises of tin, indium, silicon, gallium, aluminum, titanium, zirconium, niobium, germanium, antimony, bismuth, zinc, gold, platinum, palladium, nickel, iron, cobalt, chromium, magnesium, cesium, cerium, molybdenum, silver, sodium, potassium, calcium, yttrium, tantalum, hafnium, barium, vanadium, strontium, tellurium, lanthanum, or a combination thereof.

16. The anode-solid electrolyte sub-assembly of claim 8, wherein an average pore size of the interlayer is about 0.1 nanometer to about 100 nanometers, and
an average pore size of the plurality of open pores of the mixed ionic-electronic conductor structure is greater than the average pore size of the interlayer.

17. The anode-solid electrolyte sub-assembly of claim 1, wherein the mixed ionic-electronic conductor has a shape of a vertical nanotube extending in the direction from the anode current collector towards the solid electrolyte,
wherein the vertical nanotube has an average diameter of about 5 nanometers to about 200 nanometers and an average length of about 1 micrometer to about 100 micrometers.

18. A solid secondary battery comprising:
a cathode; and
the anode-solid electrolyte sub-assembly of claim 1 disposed on the cathode,
wherein a solid electrolyte of the anode-solid electrolyte subassembly is disposed between the cathode and an anode.

19. The solid secondary battery of claim 18, wherein the solid electrolyte comprises an oxide solid electrolyte, a sulfide electrolyte, a polymer electrolyte, or a combination thereof.

20. A method of manufacturing a solid secondary battery, the method comprising:
preparing a mixed ionic-electronic conductor structure, the mixed ionic-electronic conductor structure comprising a plurality of open portions that extend in a direction and have a structure wherein at least one end of an open portion of the plurality of open portions is open;
arranging a plurality of lithiophilic metal material particles on the mixed ionic-electronic conductor structure to prepare a mixed ionic-electronic conductor structure on which the plurality lithiophilic metal material particles are disposed;
arranging an interlayer on the mixed ionic-electronic conductor structure on which the plurality of lithiophilic metal material particles are disposed, to prepare the mixed ionic-electronic conductor structure on which the interlayer is disposed;
stacking the mixed ionic-electronic conductor structure on which the interlayer is disposed on an anode current collector, to prepare a stack, wherein the mixed ionic-electronic conductor structure is disposed between the interlayer and the anode current collector;
arranging a solid electrolyte on the interlayer of the stack to form an anode-solid electrolyte sub-assembly; and
arranging a cathode on another side of the solid electrolyte of the anode-solid electrolyte sub-assembly to manufacture the solid secondary battery.
